(19) United States
(12) Patent Application Publication
(10) Pub. No.: US 2005/0164117 A1
(43) Pub. Date: Jul. 28, 2005

(54) Diffusion transfer film unit for seal print

(75) Inventor: Munehisa Fujita, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/038,184

(22) Filed: Jan. 21, 2005

(30) Foreign Application Priority Data
Jan. 26, 2004 (JP) 2004-017316

(51) Int. Cl. G03C 8/00

(52) U.S. Cl. 430/199

(57) ABSTRACT

A diffusion transfer film unit, containing a light-sensitive sheet, a transparent cover sheet, and a light-shielding alkaline processing composition, in which an adhesive layer and a peeling-agent layer are arranged so that they are adjacent to each other, the adhesive layer and the peeling-agent layer are disposed at a position closer to a light-exposure position than an image-receiving layer in the light-sensitive sheet or at any position in the transparent cover sheet, and the adhesive layer is disposed on the side closer to the image-receiving layer than the peeling-agent layer.

### FIELD OF THE INVENTION

The present invention relates to a diffusion transfer film unit.

The present invention relates, particularly, to an integrated type color diffusion transfer film unit having a constitution in which a light-sensitive element is applied together with an image-receiving element on the same transparent support (specifically, a constitution in which a white reflecting layer is provided between the image-receiving element and the light-sensitive element). Specifically, the invention relates to a color diffusion transfer film unit, comprising a light-sensitive sheet, provided with an image-receiving layer, a white reflecting layer, a light-shielding layer, and at least one silver halide emulsion layer combined with at least one dye-image-forming material, on a transparent support; a transparent cover sheet, provided with a neutralizing layer and a neutralizing timing layer, on another transparent support; and a light-shielding alkaline processing composition, disposed so as to be developed between the light-sensitive sheet and the transparent cover sheet.

Also, the present invention relates to an integrated type color diffusion transfer film unit, which can be used in a non-peeled state and which can be used also as a seal print by peeling off. Further, the present invention also relates to a color diffusion transfer film unit excellent in high curling preventive characteristics and image fastness, even when it is put in a seal print state. Furthermore, the present invention also relates to a color diffusion transfer film unit fit to applications for applying an image to, for example, identification cards, notes, and albums.

### BACKGROUND OF THE INVENTION

The color diffusion transfer film unit includes an integrated type and a divided type. A typical example of the divided type is a peel-apart type, in which a light-sensitive element and a dye-image-receiving element are applied to separate supports; wherein, after an image is exposed to light, the light-sensitive element and the dye-image-receiving element are overlapped on each other, and a processing composition is developed (permeated) between the two elements, and thereafter, the dye-image-receiving element is peeled off, to thereby obtain a dye-image transferred to the dye-image-receiving layer. The characteristics of this constitution are that, unlike the integrated type, which will be explained later, an image is not observed through the support but a dye-image can be directly observed, and therefore, the constitution is free from deterioration in image quality and exhibits excellent color reproducibility. However, this constitution has the operational disadvantage that the light-sensitive element is made to be overlapped on the image-receiving element in a camera, and the disadvantage in handling a treated film that, after the sheet is peeled off, the alkaline processing solution is sticky and is easily stuck to the surroundings.

The integrated-type constitution is one improved in these operational and handling disadvantages. An integrated type diffusion transfer film unit is well known, as shown in many documents, such as Research Disclosure, Vol. 151, No. 15162 (1976), and Photographic Science and Engineering, Vol. 20, No. 4, Jul. 18 (1976). In the integrated type, a dye image-receiving layer, a light-sensitive element, and a neutralizing timing element are applied between a transparent support and another support. The integrated type includes a constitution in which the light-sensitive element and the image-receiving element are applied to the same transparent support, and a constitution in which the light-sensitive element and the image-receiving element are applied to separate supports. A white reflecting layer is formed by application between the image-receiving element and the light-sensitive element in the former case, and a processing composition developed between the image-receiving element and the light-sensitive element is made to contain a white pigment in the latter case, so that a dye image transferred to an image-receiving layer can be observed by reflected light.

However, although the integrated type diffusion transfer film unit is simplified in operation method and easy in handling, it is bulky, as two supports are used and it has a constitution with a pod for a spent processing solution and a trap for an excess processing solution. This bulkiness hinders application of the unit to albums or various mounts to file the unit, or in the way to laminate the units to preserve them, after development of the unit.

Further, when the film unit is used as a seal print to apply to, for example, a note or album, a method is proposed in which, after the developing treatment is finished, an adhesive double-coated tape with a peelable sheet is applied to the back side of a cover sheet, to make a seal print. This method, however, makes the unit more bulky and necessitates very complicated work. Therefore, this method is impractical for a general user.

To solve this inconvenience problem, a method has been known in which a peelable (peeling) layer is introduced into a proper position of an integrated type unit material, to remove an unnecessary part after an image is formed. As an agent used to form the peelable layer, an arbitrary material may be used, and, for example, gum arabic, sodium alginate, and cellulose derivatives, as described in U.S. Pat. Nos. 3,730,718 and 3,820,999, may be used. Moreover, to make peeling easy, there is a disclosure in U.S. Pat. No. 4,499,174 intending to make it easy to peel a peelable layer by adopting a constitution that is provided with a hydrophilic layer different from a light-sensitive silver halide emulsion layer, or from an image-receiving layer as one of layers adjacent to the peelable layer, and the constitution contains a light-insensitive granular material in another adjacent layer. Further, JP-A-5-313330 (“JP-A” means unexamined published Japanese patent application) discloses a color diffusion transfer film unit having a peelable layer.

However, these methods do not solve a problem that a large amount of structural materials is required for the peelable layer, or peeling characteristics deteriorate with time. Further, the integrated-type diffusion film unit has the drawback that, if it is peeled off, the light fastness of an image is outstandingly deteriorated, and curling characteristics are deteriorated, and there are strong needs to solve these various problems. Further, a unit having a constitution that can be easily used for a seal print has been desired in recent years.

### SUMMARY OF THE INVENTION

The present invention resides in a diffusion transfer film unit, comprising:
(i) a light-sensitive sheet provided, on a transparent support, with an image-receiving layer, a white reflecting layer, a light-shielding layer and at least one silver halide emulsion layer combined with at least one dye-image-forming substance in this order, on the side of transparent cover sheet described below;
(ii) a transparent cover sheet provided, on another support, with a neutralizing layer and a neutralizing timing layer in this order on the light-sensitive sheet side; and
(iii) a light-shielding alkaline processing composition to be developed between the light-sensitive sheet and the transparent cover sheet;
in which (i) the light-sensitive sheet, (ii) the transparent cover sheet and (iii) the light-shielding alkaline processing composition are arranged such that the diffusion transfer film unit is exposed to light through the transparent cover sheet;
wherein an adhesive layer and a peeling-agent layer are arranged so that they are adjacent to each other, the adhesive layer and the peeling-agent layer are disposed at a position closer to the light-exposure position than the image-receiving layer in the light-sensitive sheet or at any position in the transparent cover sheet, and the adhesive layer is disposed on the side closer to the image-receiving layer than the peeling-agent layer.

Other and further features and advantages of the invention will appear more fully from the following description.

### DETAILED DESCRIPTION OF THE INVENTION

According to the present invention, there are provided the following means:
(1) A diffusion transfer film unit, comprising:
   (i) a light-sensitive sheet provided, on a transparent support, with an image-receiving layer, a white reflecting layer, a light-shielding layer and at least one silver halide emulsion layer combined with at least one dye-image-forming substance in this order, on the side of transparent cover sheet described below;
   (ii) a transparent cover sheet provided, on another support, with a neutralizing layer and a neutralizing timing layer in this order on the light-sensitive sheet side; and
   (iii) a light-shielding alkaline processing composition to be developed between the light-sensitive sheet and the transparent cover sheet;
   in which (i) the light-sensitive sheet, (ii) the transparent cover sheet and (iii) the light-shielding alkaline processing composition are arranged such that the diffusion transfer film unit is exposed to light through the transparent cover sheet;
   wherein an adhesive layer and a peeling-agent layer are arranged so that they are adjacent to each other, the adhesive layer and the peeling-agent layer are disposed at a position closer to the light-exposure position than the image-receiving layer in the light-sensitive sheet or at any position in the transparent cover sheet, and the adhesive layer is disposed on the side closer to the image-receiving layer than the peeling-agent layer;
(2) A diffusion transfer film unit, comprising:
   (i) a light-sensitive sheet provided, on a transparent support, with an image-receiving layer, a white reflecting layer, a light-shielding layer and at least one silver halide emulsion layer combined with at least one dye-image-forming substance in this order, on the side of transparent cover sheet described below;
   (ii) a transparent cover-sheet provided, on a lamination-type transparent support having a constitution in which an adhesive layer and a peeling-agent layer are sandwiched between two supports, with a neutralizing layer and a neutralizing timing layer in this order on the light-sensitive sheet side; and
   (iii) a light-shielding alkaline processing composition to be developed between the light-sensitive sheet and the transparent cover sheet;
   in which (i) the light-sensitive sheet, (ii) the transparent cover sheet and (iii) the light-shielding alkaline processing composition are arranged such that the diffusion transfer film unit is exposed to light through the transparent cover sheet;
(3) The diffusion transfer film unit according to the above item (2), wherein each thickness of the two supports constituting the lamination-type transparent support satisfies the relationship given by the following equations:
   B1(Th)≦B2(Th),
   50 μm≦B1(Th)+B2(Th)≦150 μm
   wherein, B1(Th) represents the thickness of the support on the neutralizing layer side, and B2(Th) represents the thickness of the support on the side opposite to the neutralizing layer;
(4) The diffusion transfer film unit according to the above item (2) or (3), wherein the lamination-type transparent support comprises a polyester film;
(5) The diffusion transfer film unit according to any one of the above items (1) to (4), wherein the silver halide emulsion in the light-sensitive sheet comprises an internal-latent-image-type direct positive silver halide emulsion;
(6) The diffusion transfer film unit according to any one of the above items (1) to (4), wherein the silver halide emulsion in the light-sensitive sheet comprises a negative type silver halide emulsion; and
(7) The diffusion transfer film unit according to any one of the above items (1) to (6), wherein the diffusion transfer film unit is exposed to light by using an exposure head having plural light sources different from each other each emitting light in a specific wavelength region.

An embodiment to carry out the present invention will be explained in detail.

In the present specification, the “seal print” means a print in which an image is printed on a sheet with a peeled portion, so that the printed image may be used as a seal or sticker.

First, a lamination-type transparent support that can be used in the present invention will be explained.

The lamination-type transparent support means a lamination-type transparent support having a constitution in which an adhesive layer and a peeling-agent layer are sandwiched between two supports. In a preferable embodiment of the color diffusion transfer film unit of the present invention, the lamination-type transparent support is used to manufacture a transparent cover sheet. After a light-sensitive sheet is exposed to light through this transparent cover sheet, development is conducted by developing (permeating) treatment of an alkaline processing composition.

The details of this exposure and developing system are described, for example, in JP-A-7-159931. The position where the developed sample is peeled is the boundary between the adhesive layer and the peeling-agent layer in, for example, the lamination-type transparent support. When the unit of the present invention is used as a seal print, after cutting into a desired shape, it is peeled at the boundary between the adhesive layer and the peeling-agent layer, and then applied to a desired base body by using the adhesive-layer surface corresponding to the backface of an image surface. Therefore, the unit is cut corresponding to the intended object and applied to a target material.

The lamination-type transparent support that can used in the present invention is preferably one which is as thin as possible to the extent that it can be handled when the cover sheet is produced, and which has high rigidity, because the handling easiness differs depending on thickness and rigidity. As the transparent support, a plastic film is preferably used. Examples of the plastic film include films of polyesters, such as a polyethylene terephthalate, polyethylene naphthalate, and modified polyesters; films of polyolefins, such as a polyethylene and polypropylene; polystyrene films, polyvinyl chloride films and polycarbonate films. These can be all used, but, among these films, polyester films are more preferable.

In the present invention, the lamination-type transparent support having a constitution in which the adhesive layer and the peeling-agent layer are sandwiched between two supports (base) is preferably used. Each thickness of the above two bases preferably satisfy the relationship given by the following equations, from the viewpoint of making the seal print as thin as possible, making it easy to handle when the cover sheet is produced, and making it easy to permeate the processing composition.
B1(Th)≦B2(Th),
50 μm≦B1(Th)+B2(Th)≦150 μm

In the above-described equations, B1(Th) represents thickness of the base on the neutralizing layer side; and B2(Th) represents thickness of the base on the side opposite to the neutralizing layer. Further, (B1(Th)+B2(Th)) is more preferably in a range of from 50 μm to 100 μm.

The lamination-type transparent support that can be used in the present invention is preferably subject to a surface treatment or a formation of an undercoat layer thereon. The adhesion of the adhesive layer to the support enables sufficient adhesive strength to be obtained without carrying out undercoat treatment. However, there is the case where the undercoat treatment is carried out to reinforce the adhesion of the adhesive layer, if necessary. The surface treatment and the formation of the undercoat layer are generically called undercoat treatment. This undercoat treatment will be hereinafter explained.

The surface of the lamination-type transparent support on the side coated with the neutralizing layer may be subjected to an activating treatment, such as corona discharge treatment, flame treatment, glow discharge treatment, ultraviolet ray radiation treatment, high-frequency treatment, activated plasma treatment or laser treatment. Only this treatment is enough to stick the neutralizing layer. However, there is also the case where the support is insufficiently stuck to the neutralizing layer depending on the producing method of the neutralizing layer. In this case, it is preferable to apply an acryl resin or the like thereto, after the activating treatment, such as corona discharge treatment.

Also, a solvent-containing (for example, acetone) coating solution containing a hydrophilic resin (for example, a copolymer of maleic anhydride/vinyl acetate) for the undercoating can be applied to both surfaces in the cases that the surface is subjected to the corona discharge treatment or the like, and that the corona discharge treatment or the like is not conducted. Also, this undercoat treatment may be carried out in the same method as in the case of the usual undercoat treatment of a oriented polyethylene terephthalate support. Specifically, in a method as described in, for example, JP-A-55-67745 and JP-A-59-19941, an aqueous undercoating solution comprising a quaternary copolymer latex constituted of n-butylmethacrylate, t-butylmethacrylate, styrene and 2-hydroxyethylmethacrylate, a surfactant and a hardener is applied to the surface and dried, and in succession, the coating layer is subjected to, for example, corona discharge treatment, to complete the undercoat treatment. The resin-layer surface on the side coated with the neutralizing layer and the resin-layer surface on the backside may be subjected to the similar undercoat treatment. After the treatment similar to the above is carried out or an undercoat layer is formed, an anti-static layer is formed by applying an anti-static composition directly to the back surface; or after a binder, such as cellulose diacetate for an anti-static layer is applied to the back surface in advance, an anti-static composition is applied thereto as an organic-solvent solution, whereby a desired support can be prepared.

Such a lamination-type support is also described in JP-A-8-220691. However, this is concerned with a method of using a lamination-type support deposited on a support provided with the light-sensitive layer, at the side opposite to the light-sensitive layer. Therefore, this method is different in point of idea and design from a system used in the present invention in which the lamination-type support is disposed on the light-sensitive layer side, and light exposure are carried out through the lamination-type support.

Peeling-Agent Layer

In a preferable embodiment of the present invention, a peeling-agent layer is applied to the support, constituting the lamination-type transparent support and disposed on the side opposite to the neutralizing layer, on the neutralizing layer side. As the peeling-agent, one having a dynamic friction coefficient range from 0.20 to 0.50 is preferable, and an arbitrary peeling-agent, such as a silicon-resin type, fluororesin type, higher fatty acid type, soap, wax, and animal or vegetable oil may be used. Arbitrary silicon resins known in peel-type sheet industries may be also used, and specific examples of such a peeling agent include SD-7239, BY24-162, LTC-300B, LTC-350A, BY14-403, BY14-405, BY14-407, BY14-413, BY14-414, BY-14-411 and BY14-420 manufactured by Dow Coning Toray Silicone Co., Ltd., and KS-845, KS-770, KNS-202A, KNS-305, KNS-316, KNS-319, KNS-320, X-62-1232 and X-62-1233 manufactured by Shin-Etsu Chemical Co., Ltd. The coating amount of the peeling agent to be applied is preferably 0.4 to 2.0 g/m² and particularly preferably 0.6 to 1.3 g/m².

The thickness of the peeling-agent layer is, though not particularly limited, generally 0.4 to 2.00 μm and preferably 0.6 to 1.3 μm.

Adhesive Layer

As the adhesive, those having high transparency and a proper adhesive power can be used. The adhesive to be required is one, for instance, not to adhere to, for example, a rotary slitter cutter or a Guillotine cutter when a lamination-type support is cut; to have adhesion enough to prevent peeling in the course of the coating step, cutting processing and permeating processing step; to adhere firmly to the support not to be peeled off; and to have adhesion enough to adhere to a target material after peeled off. Such a demand is satisfied when the adhesive layer formed by application on a support (for example, a polyester film) has an adhesion of 300 g to 2,000 g/25 mm width as an adhesion according to JIS Z 1538 to a flat stainless plate whose surface is cleaned by a defatting solvent.

The adhesive used in the present invention may be selected from those known in adhesive industries, for example, ethylene/vinyl acetate resins, acryl-type emulsion resins, vinyl chloride-type resins, vinylidene chloride-type resins, synthetic rubber-type resins and natural rubber-type resins. Among these resins, those satisfying the above requirement are preferably used in the present invention.

Examples of the adhesive that are preferably used in the present invention include BPS-3233D, BPS-8170, BPS-3841, BPS-5215, BPS-1109, BPS-4849 and BPS-5569K manufactured by TOYO INK MFG. CO., LTD.; SK-1717, SK-1233, SK-1435, SK-1473H and SK-1633H manufactured by Soken Chemical & Engineering Co., Ltd.; and Corponeel 2233, Corponeel 3816 and Corponeel 5859B (each trade name) manufactured by The Nippon Synthetic Chemical Industry Co., Ltd. Also, acryl-type latexes as described in JP-A-4-298586 and JP-A-3-6277 may be used. The adhesive includes solvent-type adhesives, emulsion-type adhesives and hot melt type adhesives. As a machine used to apply these adhesives, a comma coater, reverse roll coater, air knife coater, knife coater or a dye coater may be used.

The amount of the adhesive to be applied according to the present invention is preferably in a range from 5 to 40 g/m², and particularly preferably 10 to 30 g/m² from the viewpoint of cutting easiness and stability of adhesion after used.

The thickness of the adhesive layer used in the present invention is generally 5 to 40 μm and preferably 10 to 30 μm, though there is no particular limitation to the thickness.

The adhesive force of the adhesive is measured in the following manner. Specifically, the above-described adhesive is applied to one of the surfaces of a commercially available 100-μm-thick polyethylene terephthalate film which is separately prepared such that the coating amount is 15 g/m², and dried. Then, the film is cut into a size of 25 mm×500 mm (part coated: 25 mm×250 mm), and the adhesive surface of the cut film is then stuck to 25 mm×500 mm in size of a flat stainless plate cleaned by an alcohol, in the condition of 23° C. and 55% RH. The film and the stainless plate are overlapped on each other, and the parts having no adhesive layer face each other. The film and the stainless plate are applied to each other by pressing with a 2 kg roller wherein the roller is made to go back and force three times on the film. After 24 hours, in the condition of 23° C. and 55% RH according to JIS Z 1538, the one end, in which no adhesive layer is applied, of the stainless plate is secured by the clamp of Instron tension tester, whereas the one end, in which no adhesive layer is applied, of the polyethylene terephthalate film is allowed to hang down and its distal end is fastened by the lower clamp of the tester to measure a load when the polyethylene terephthalate film is pulled and peeled in a direction at an angle of 180 degrees to the end, secured by the clamp, of the stainless plate at a rate of 300 mm/minute by the Instron tension tester.

A pigment, such as titanium oxide, calcium carbonate, barium sulfate, zinc oxide, silica, kaolin and clay; an antistatic agent, an antiseptic, a perfume and the like may be added in the adhesive layer used in the present invention to the extent that the aforementioned adhesive characteristics are not impaired. Also, a water-soluble plasticizer as described in JP-A-4-298586 may be added.

As a preparation method of the lamination-type transparent support that can be used in the present invention, for example, after a peeling-agent is applied to a support B2 (a support disposed on the side opposite to the neutralizing layer), an adhesive is applied to the peeling agent, and then, the resulting support B2 and a support B1 (a support disposed on the neutralizing layer side) are laminated on each other by using a press roll to produce the lamination-type transparent support. Also, the lamination-type transparent support may be produced by another method in which an adhesive is applied to the support B1, and the peeling-agent-layer-coated surface of the support B2 produced previously is applied to the adhesive-layer-coated surface of the support B1 by a press roll. Thereafter, each layer constituting a cover sheet is applied to the obtained lamination-type transparent support. Further, the following method may be adopted. Specifically, each layer constituting a cover sheet is applied to the support B1. Separately, a back layer, as described in the Examples, is applied to the surface of the support B2, and then, a peeling agent is applied to the opposite surface. Then, the surface opposite to the neutralizing layer, of the support B1, is applied to the peeling-agent-coated surface of the support B2 by a press roll so as to sandwich an adhesive between the both surfaces. In the present invention, any of these methods may be used, though the present invention is not limited to these methods. A method like the former method is rather preferable in which the lamination-type transparent support is produced and then each layer constituting a cover sheet is applied, from the viewpoint of easiness in the preparation.

Each structural element, which may be used for the diffusion-transfer film unit of the present invention, will be hereinafter explained.

I. Light-Sensitive Sheet

A) Support

As the support of the light-sensitive sheet for use in the present invention, any one of smooth transparent supports, which are usually used for photographic light-sensitive materials, may be used. For example, cellulose acetate, polystyrene, polyethylene terephthalate, polycarbonate, and the like is used. The support is preferably provided with an undercoat layer. The support preferably contains a minute amount of a dye or pigment such as titanium oxide in general, to prevent light-piping. The thickness of the support of the light-sensitive sheet is generally 25 to 350 μm, preferably 50 to 210 μm, and more preferably 70 to 150 μm. A curl-balancing layer, or an oxygen-shielding layer as described in JP-A-56-78833 may be applied to the backside of the support according to the need.

B) Image-Receiving Layer

The image-receiving layer (dye-receiving layer) for use in the present invention is a layer containing a mordant in a hydrophilic colloid. This layer may be a single layer or may have a multilayer constitution, in which mordants having different mordant powers are coated such that they are overlapped on each other. There are descriptions concerning this in JP-A-61-252551. As the mordants, polymer mordants are preferable.

The polymer mordants are, for example, polymers containing a secondary or tertiary amino group, polymers having a nitrogen-containing heterocyclic moiety, and polymers containing a quaternary cation, and those having a molecular weight of generally 5,000 or more, and particularly preferably 10,000 or more. The amount of the mordant to be applied is generally 0.5 to 10 g/m², preferably 1.0 to 5.0 g/m², and particularly preferably 2 to 4 g/m².

As the hydrophilic colloid for use in the image-receiving layer of the light-sensitive sheet, a gelatin, polyvinyl alcohol, polyacrylamide, polyvinylpyrrolidone, or the like can be used, and a gelatin is preferably used.

An anti-fading agent as described in JP-A-62-30620, JP-A-62-30621, and JP-A-62-215272, may be incorporated into the image-receiving layer.

The thickness of the image-receiving layer for use in the present invention is not particularly limited.

C) White Reflecting Layer

A white reflecting layer forms a white background of a color image. The white reflecting layer for use in the present invention generally contains a white pigment and a hydrophilic binder.

As the white pigment for the white reflecting layer, barium sulfate, zinc oxide, barium stearate, silver flakes, silicates, alumina, zirconium oxide, sodium zirconium sulfate, kaolin, mica, titanium dioxide, or the like can be used. Further, non-filming polymer particles made of styrene or the like can also be used. Also, these pigments may be used singly, or by mixing them as far as an intended reflectance is obtained.

A particularly useful white pigment is titanium dioxide.

The whiteness of the white reflecting layer varies depending on the type of pigment, the mixing ratio of the pigment and the binder, and the amount of the pigment to be applied. It is, however, preferable that the layer has light reflectance of 70% or more.

When titanium dioxide is used as the white pigment, a white reflecting layer, which is coated with titanium dioxide in an amount of generally 5 to 40 g/m², and preferably 10 to 25 g/m², and has a light reflectance of 78 to 85% for light having a wavelength of 540 nm, is preferable. Titanium dioxide may be selected from a variety of commercially available brands for use.

Among these, particularly, rutile type titanium dioxide is preferably used. Most of commercially available products are surface-treated using alumina, silica, zinc oxide, or the like. Titanium dioxide, which is surface-treated to an extent of 5% or more in amount, is preferable to obtain a high reflectance. Examples of commercially available titanium dioxide include those described in Research Disclosure No. 15162, besides Ti-pure R931 (trade name) manufactured by Du Pont K.K.

As the binder for the white reflecting layer, an alkali-penetrative polymer matrix, for example, a gelatin, polyvinyl alcohol, and cellulose derivative such as hydroxyethyl cellulose, and carboxymethyl cellulose, may be used. A particularly desirable binder for the white reflecting layer is a gelatin. When a gelatin is used as the binder, the mass ratio of the white pigment to the gelatin is generally 1/1 to 20/1, and preferably 5/1 to 10/1.

An anti-fading agent as described in JP-B-62-30620 (“JP-B” means examined Japanese patent publication) and JP-B-62-30621 is preferably incorporated into the white reflecting layer.

D) Light-Shielding Layer

A light-shielding layer containing a light-shielding agent and a hydrophilic binder may be provided between the above-described white reflecting layer and the light-sensitive layer described later.

As the light-shielding agent, any material having a light-shielding function can be used, and carbon black is preferably used. Decomposable dyes described, for example, in U.S. Pat. No. 4,615,966 may also be used.

As the binder to coat the light-shielding agent, any binder may be used as far as it can disperse the light-shielding agent, such as carbon black, and gelatin is preferable.

As the methods of producing the carbon black, those produced by an arbitrary method, such as a channel method, thermal method, and furnace method, as described, for example, by Donnel Voet, “Carbon Black”, Marcel Dekker, Inc. (1976), can be used. Although no particular limitation is imposed on the size of a carbon black particle, those having a particle size of 90 to 1,800 Å are preferable. The amount of a black pigment to be added as the light-shielding agent may be controlled corresponding to the sensitivity of the light-sensitive material to be shielded, but the amount is preferably about 5 to about 10 in terms of optical density.

The thickness of the light-shielding layer for use in the present invention is not particularly limited.

E) Light-Sensitive Layer

In the present invention, a light-sensitive layer comprising at least one silver halide emulsion layer combined with at least one dye-image-forming substance (dye-image-forming compound) is provided adjacent to the aforementioned light-shielding layer. Structural elements thereof will be hereinafter explained.

(1) Dye-Image-Forming Compound

Specific examples of the dye-image-forming compound are described in the following literatures.

Examples of Yellow Dyes:

Those described in U.S. Pat. No. 3,597,200, No. 3,309,199, No. 4,013,633, No. 4,245,028, No. 4,156,609, No. 4,139,383, No. 4,195,992, No. 4,148,641, No. 4,148,643, and No. 4,336,322; JP-A-51-114930, JP-A-56-71072; and Research Disclosures No. 17630 (1978) and No. 16475 (1977).

Examples of Magenta Dyes:

Those described in U.S. Pat. No. 3,453,107, No. 3,544,545, No. 3,932,380, No. 3,931,144, No. 3,932,308, No. 3,954,476, No. 4,233,237, No. 4,255,509, No. 4,250,246, No. 4,142,891, No. 4,207,104, and No. 4,287,292; JP-A-52-106727, JP-A-53-23628, JP-A-55-36804, JP-A-56-73057, JP-A-56-71060, JP-A-55-134, JP-A-7-120901, JP-A-8-286343, JP-A-8-286344, and JP-A-8-292537.

Examples of Cyan Dyes:

Those described in U.S. Pat. No. 3,482,972, No. 3,929,760, No. 4,013,635, No. 4,268,625, No. 4,171,220, No. 4,242,435, No. 4,142,891, No. 4,195,994, No. 4,147,544, and No. 4,148,642; U.K. Patent No. 1,551,138; JP-A-54-99431, JP-A-52-8827, JP-A-53-47823, JP-A-53-143323, JP-A-54-99431, JP-A-56-71061; European Patents (EP) No. 53,037 and No. 53,040; and Research Disclosures No. 17,630 (1978) and No. 16,475 (1977).

Dye image-forming compounds, which each form a dye upon coupling, may be used. For example, these compounds are described in JP-A-8-286340, JP-A-9-152705, and Japanese Patent Applications No. 8-357190, No. 8-357191, and No. 9-117529, and the like.

Positive type dye-image-forming compounds may also be used. In this case, a negative type silver halide emulsion may be used as the silver halide emulsion. Examples thereof are described in JP-A-4-156542, JP-A-4-155332, JP-A-4-172344, JP-A-4-172450, JP-A-4-318844, JP-A-4-356046, JP-A-5-45824, JP-A-5-45825, JP-A-5-53279, JP-A-5-107710, JP-A-5-241302, JP-A-5-107708, JP-A-5-232659, and U.S. Pat. No. 5,192,649.

These compounds can be dispersed by a method described in JP-A-62-215272, pp. 144-146. Also, dispersions of these compounds may contain a compound described in JP-A-62-215272, pp. 137-144. As specific examples of these dye-image-forming compounds, the following compounds may be given. “Dye” in the following compounds respectively represents a dye group, a dye group that is temporarily short-waved, or a dye precursor group. 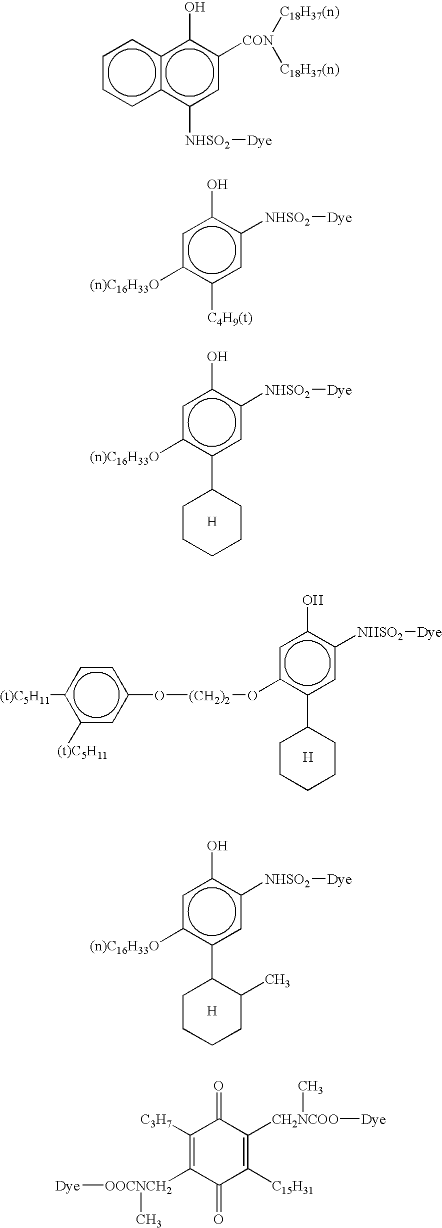 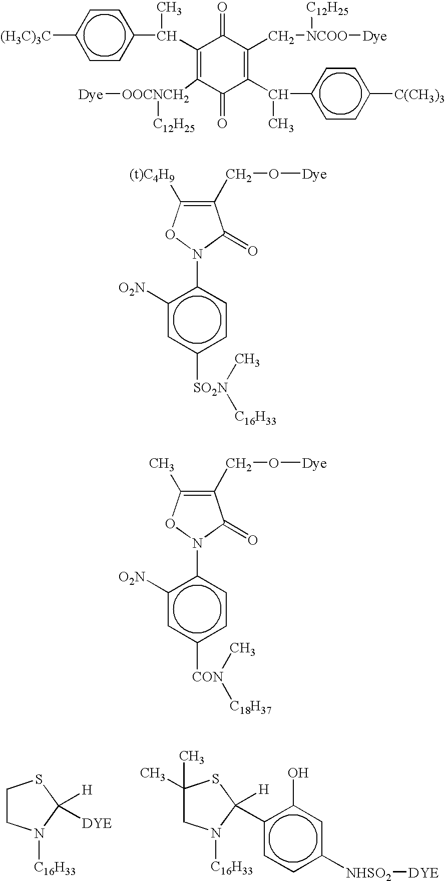
(2) Silver Halide Emulsion

The silver halide emulsion for use in the present invention may be either a negative type emulsion, which forms a latent image mainly on the surface of a silver halide particle, or an internal-latent-image-type direct positive emulsion, which forms a latent image inside of a silver halide particle.

Examples of the internal-latent-image-type direct positive emulsion include a so-called “conversion type” emulsion, which is produced by making use of a difference in the solubility between silver halides, and a “core/shell type” emulsion produced by coating at least the light-sensitive site of an internal nucleus (core) particle of a silver halide with an external shell of a silver halide, wherein the internal core particle is doped with a metal ion, chemically sensitized, or provided with the both treatments, and other emulsions. These emulsions are described in U.S. Pat. No. 2,592,250 and No. 3,206,313, U.K. Patent No. 1,027,146, U.S. Pat. No. 3,761,276, No. 3,935,014, No. 3,447,927, No. 2,297,875, No. 2,563,785, No. 3,551,662 and No. 4,395,478, West Germany Patent No. 2,728,108, U.S. Pat. No. 4,431,730, and the like.

When an internal-latent-image-type direct positive emulsion is used, it is necessary to provide surface fog nuclei by use of light or a nucleating agent after image-wise exposure. Examples of the nucleating agent to be used for the above-mentioned purpose include hydrazines described in U.S. Pat. Nos. 2,563,785 and 2,588,982; hydrazines and hydrazones described in U.S. Pat. No. 3,227,552; heterocyclic quaternary salt compounds described in U.K. Patent No. 1,283,835, JP-A-52-69613, U.S. Pat. Nos. 3,615,615, 3,719,494, 3,734,738, 4,094,683 and 4,115,122, and others; sensitizing dyes having a substituent capable of nucleation in the dye molecule described in U.S. Pat. No. 3,718,470; thiourea linkage-type acylhydrazine-based compounds described in U.S. Pat. Nos. 4,030,925, 4,031,127, 4,245,037, 4,255,511, 4,266,013, and 4,276,364, U.K. Patent No. 2,012,443, and others; and acylhydrazine-based compounds combined together by using a thioamide ring or a heterocyclic group, such as triazole or tetrazole, as an adsorbing group, which described in U.S. Pat. Nos. 4,080,270 and 4,278,748, U.K. Patent No. 2,011,391B, and the like.

In the present invention, a spectral sensitizing dye may be used in combination with these negative type emulsion or internal-latent-image-type direct positive emulsion. Specific examples of the spectral sensitizing dye are described in JP-A-59-180550, JP-A-60-140335, Research Disclosure (RD) No. 17029, U.S. Pat. No. 1,846,300, U.S. Pat. No. 2,078,233, U.S. Pat. No. 2,089,129, U.S. Pat. No. 2,165,338, U.S. Pat. No. 2,231,658, U.S. Pat. No. 2,917,516, U.S. Pat. No. 3,352,857, U.S. Pat. No. 3,411,916, U.S. Pat. No. 2,295,276, U.S. Pat. No. 2,481,698, U.S. Pat. No. 2,688,545, U.S. Pat. No. 2,921,067, U.S. Pat. No. 3,282,933, U.S. Pat. No. 3,397,060, U.S. Pat. No. 3,660,103, U.S. Pat. No. 3,335,010, U.S. Pat. No. 3,352,680, U.S. Pat. No. 3,384,486, U.S. Pat. No. 3,623,881, U.S. Pat. No. 3,718,470, U.S. Pat. No. 4,025,349, and the like.

(3) Constitution of the Light-Sensitive Layer

To reproduce a natural color by a subtractive color process, a light-sensitive layer that comprises at least two combinations of the emulsion, which is spectrally sensitized by the above spectral sensitizing dye, and the aforementioned dye-image-forming compound, which donates a dye having selective spectral absorption in the same wavelength range as the emulsion, may be used.

The emulsion and the dye-image-forming compound may be coated such that they are overlayer as separate layers, or may be coated as one layer by mixing them. When the dye-image-forming substance has absorption in the spectral sensitive range of the emulsion combined therewith, in the condition that the dye-image-forming substance is applied, the separate layer system is preferable. Also, the emulsion layer may consist of a plurality of emulsion layers having different sensitivities, and further an optional layer may be formed between the emulsion layer and the dye-image-forming compound layer. For example, a layer containing a nucleating development accelerator, as described in JP-A-60-173541, or a bulkhead layer as described in JP-B-60-15267, is formed to raise the density of a color image, and also a reflecting layer may be formed to improve the sensitivity of the light-sensitive element.

The reflecting layer is a layer generally containing a white pigment and a hydrophilic binder. The white pigment is preferably titanium oxide and the hydrophilic binder is preferably a gelatin. The amount of titanium oxide to be applied is generally 0.1 g/m² to 8 g/m², and preferably 0.2 g/m² to 4 g/m². Examples of the reflecting layer are described in JP-A-60-91354.

In a preferable multilayer constitution of the light-sensitive layer for use in the present invention, a combination unit of a blue-sensitive emulsion, a combination unit of a green-sensitive emulsion, and a combination unit of a red-sensitive emulsion are arranged in order, from the exposure side. Arbitrary optional layers may be provided as required between each emulsion layer units, respectively. Particularly, intermediate layers are preferably formed to prevent an undesirable influence of the effect due to the development of a certain emulsion layer, on other emulsion layer unit.

As necessary, an irradiation-preventing layer, a layer containing a UV absorbing agent, a protective layer, and the like may be also formed in the present invention.

The thickness of the light-sensitive layer for use in the present invention is not particularly limited.

The thickness of the light-sensitive sheet for use in the present invention is not particularly limited.

II. Transparent Cover Sheet

It is preferable that the color diffusion-transfer film unit of the present invention is provided with neutralizing function on the transparent cover sheet.

F) Support

As the support of the cover sheet used in the present invention, any transparent support having the constitution of the lamination-type transparent support explained above can be preferably used. The constitution and thickness of the lamination-type transparent support, a preferable film constituting the support, the undercoat treatment of the lamination-type transparent support, and the method of producing the lamination-type transparent support are explained above.

The support of the cover sheet used in the present invention is unnecessarily the aforementioned lamination-type transparent support, and any smooth and transparent support, which is usually used for photographic light-sensitive materials, may be used. As a material of the support, a cellulose acetate, polystyrene, polyethylene terephthalate, polycarbonate, and the like may be used. The support is preferably provided with an undercoat layer. In this case, the thickness of the support is generally 6 to 150 μm, and preferably 20 to 90 μm. The support preferably contains a minute amount of a dye to prevent light-piping.

When the above-described lamination-type transparent support is not used as the support of the cover sheet, the above-described adhesive layer and peeling-agent layer, which are adjacent to each other and constitute the boundary to be peeled between them, may be disposed at a position closer to the light-exposure position than the image-receiving layer in the light-sensitive sheet or at an arbitrary position of the above-described transparent cover sheet (in each cases, the adhesive layer is disposed at a position closer to the image-receiving side than the peeling-agent layer). Moreover, the adhesive layer and peeling-agent layer adjacent to each other are preferably disposed at a position closer to the light-exposure side than the light-shielding layer in the light-sensitive sheet or at an arbitrary position of the transparent cover sheet, and particularly preferably disposed at a position closer to the light-exposure side than the light-sensitive layer in the light-sensitive sheet or at an arbitrary position of the transparent cover sheet, from the viewpoint of handling easiness in the production process.

The structuring materials of the peeling-agent layer are not required in a large amount, the peeling property is not deteriorated with time, an unnecessary part after an image is formed can be removed, and the diffusion transfer film unit may be used as a seal print, by disposing the adhesive layer and peeling-agent layer so as to be adjacent to each other.

G). Layer Having Neutralizing Function

The layer having neutralizing function (a neutralizing layer) for use in the present invention is a layer generally containing an acidic substance in an amount enough to neutralize an alkali delivered from the alkaline processing composition described later, and it may be one having a multilayer constitution comprising a neutralizing rate-controlling layer (neutralizing timing layer), an adhesion-reinforcing layer, and the like, according to the need.

A preferable acidic substance is a substance that contains an acidic group having a pKa of 9 or less (or a precursor group providing such an acidic group by hydrolysis). More preferable examples of the acidic substance include higher fatty acids, such as oleic acid, as described in U.S. Pat. No. 2,983,606; and polymers of acrylic acid, methacrylic acid, or maleic acid, and its partial esters or acid anhydrides, as disclosed in U.S. Pat. No. 3,362,819; copolymers of an acrylic acid and an acrylate, as disclosed in French Patent No. 2,290,699; and latex-type acidic polymers, as disclosed in U.S. Pat. No. 4,139,383 or Research Disclosure No. 16102 (1977). Besides the above compounds, acidic substances as disclosed in U.S. Pat. No. 4,088,493, JP-A-52-153739, JP-A-53-1023, JP-A-53-4540, JP-A-53-4541, JP-A-53-4542, and the like may be given as examples.

Specific examples of the acidic polymer (polymer acid), which is one of the aforementioned acidic substances, include a copolymer of a vinyl monomer, such as, ethylene, vinyl acetate and vinyl methyl ether, with maleic acid anhydride, and its n-butylester, copolymer of butylacrylate and acrylic acid, cellulose, acetate/hydrodiene phthalate, and the like.

The aforementioned acidic polymer may be used by mixing with a hydrophilic polymer. Examples of such a hydrophilic polymer include polyacrylamide, polymethylpyrrolidone, polyvinyl alcohol (including partially saponified products), carboxymethyl cellulose, hydroxymethyl cellulose, hydroxyethyl cellulose, polymethyl vinyl ether, and the like. Among these compounds, polyvinyl alcohol is preferable.

Also, a polymer, such as cellulose acetate, other than the hydrophilic polymers, may be mixed with the above acidic polymer.

The amount of the acidic polymer to be applied is controlled corresponding to the amount of an alkali in the alkaline processing composition, which will be described later. The equivalent ratio of the acidic polymer to the alkali per unit area is preferably 0.9 to 2.0. When the amount of the acidic polymer is too small, the hue of a transferred dye is changed, and stains occur on a white background portion; whereas when the amount is too large, this brings about disadvantages such as a change in the hue and reduced light resistance. A more preferable equivalent ratio is 1.0 to 1.3. The quality of photographs is also lowered if the amount of the hydrophilic polymer to be mixed is too large or too small. The mass ratio of the hydrophilic polymer to the acidic polymer is generally 0.1 to 10, and preferably 0.3 to 3.0.

Additives may be incorporated in the layer having a neutralizing function that can be used in the present invention, for various purposes. For example, a hardener well-known to a person skilled in the art may be added for the purpose of film-hardening of this layer, and a polyvalent hydroxyl compound, such as polyethylene glycol, polypropylene glycol, or glycerin (glycerol), may be added for the purpose of improving brittleness of the film in addition, an antioxidant, a fluorescent whitening agent, a development inhibitor or its precursor, and the like may be added, if necessary.

As a material for the neutralizing timing layer that can be used in combination with the neutralizing layer, useful examples are a polymer that reduces alkali-permeability, such as gelatin, polyvinyl alcohol, partially acetalized polyvinyl alcohol, cellulose acetate, or partially hydrolyzed polyvinyl acetate; a latex polymer, which is produced by the copolymerization with a small amount of a hydrophilic comonomer such as an acrylic acid monomer, and which raises an active energy for the permeation of an alkali; and a polymer having a lactone ring.

Among these polymers, cellulose acetates used for forming the neutralizing timing layer, as disclosed in JP-A-54-136328, and U.S. Pat. No. 4,267,262, No. 4,009,030, No. 4,029,849, and the like; latex polymers, which are produced by the copolymerization of a small amount of a hydrophilic comonomer such as an acrylic acid, as disclosed in JP-A-54-128335, JP-A-56-69629, JP-A-57-6843 and U.S. Pat. No. 4,056,394, No. 4,061,496, No. 4,199,362, No. 4,250,243, No. 4,256,827, No. 4,268,604, and the like; polymers having a lactone ring, as disclosed in U.S. Pat. No. 4,229,516; and other polymers as disclosed in JP-A-56-25735, JP-A-56-97346, JP-A-57-6842, European Patent (EP) No. 31,957A1, EP No. 37,724A1 and EP No. 48,412A1, and the like, are particularly useful.

In addition to the above, those described in the following literatures may also be used:

U.S. Pat. No. 3,421,893, U.S. Pat. No. 3,455,686, U.S. Pat. No. 3,575,701, U.S. Pat. No. 3,778,265, U.S. Pat. No. 3,785,815, U.S. Pat. No. 3,847,615, U.S. Pat. No. 4,088,493, U.S. Pat. No. 4,123,275, U.S. Pat. No. 4,148,653, U.S. Pat. No. 4,201,587, U.S. Pat. No. 4,288,523, U.S. Pat. No. 4,297,431, West Germany Patent Application (OLS) No. 1,622,936, ibid. 2,162,277, and Research Disclosure 15162, No. 151 (1976).

The neutralizing timing layer using these materials may be a single layer, or a combination of two or more layers.

To the neutralizing timing layer made from any of these materials may be incorporated, a development inhibitor and/or its precursor, as disclosed in, for example, U.S. Pat. No. 4,009,029, West Germany Patent Application (OLS) No. 2,913,164, ibid. No. 3,014,672, JP-A-54-155837, JP-A-55-138745 and the like; a hydroquinone precursor as disclosed in U.S. Pat. No. 4,201,578, and other useful photographic additives or their precursors. Moreover, as the layer having a neutralizing function, to provide an auxiliary neutralizing layer as described in JP-A-63-168648 and JP-A-63-168649 has an effect in view of reducing a change of transferred density due to the lapse of time after processing.

H). Others

Other than the layer having a neutralizing function, a backing layer, protective layer, filter dye layer, and the like, may be provided as layers having auxiliary functions.

The backing layer is provided to control curling, and to impart lubricity. The filter dye may be added to the backing layer.

The protective layer is used primarily to prevent adhesion to the backface of the cover sheet, specifically to prevent the adhesion of the cover sheet to the protective layer of the light-sensitive material when the light-sensitive material and the cover sheet are overlaid (superimposed) on each other. The cover sheet is allowed to contain a dye to control the sensitivity of the light-sensitive layer.

The filter dye may be added directly to the inside of a support of the cover sheet, or to the layer having a neutralizing function, and further, to the aforementioned backing layer, protective layer, or capture mordant layer. Alternatively, a single layer containing the filter dye may be formed.

III. Alkaline Processing Composition

The alkaline processing composition that can be used in the present invention is a composition, which is permeated (developed or applied) uniformly on the light-sensitive element after the light-sensitive sheet (light-sensitive element) is exposed to light, and is positioned on the backface of the support described in A) or on the side opposite to the processing solution of the light-sensitive layer, thereby forming a pair with the light-shielding layer to shield the light-sensitive layer completely from external light, and at the same time, the processing composition serves to develop the light-sensitive layer with the components contained in the composition. For this purpose, the composition may contain, for example, an alkali, a viscosity-enhancing agent, a light-shielding agent, and a developing agent, further a development accelerator, a development inhibitor, each of which controls development, and an antioxidant for preventing deterioration of a developing agent. A light-shielding agent is always contained in the composition for light-shielding.

Also, the alkaline processing composition is preferably developed on the light-sensitive element, in a development thickness (the amount of the processing solution per m², after the processing solution is transferred) of 20 to 200 μm. Further, the processing temperature in the case of processing the light-sensitive element is preferably 0 to 50° C., and more preferably 0 to 40° C.

The alkali is those sufficient to make the pH of the solution in a range from 12 to 14. Examples of the alkali include hydroxides of an alkali metal (e.g., sodium hydroxide, potassium hydroxide, lithium hydroxide), phosphates of an alkali metal (e.g., potassium phosphate), guanidines, and hydroxides of a quaternary amine (e.g., tetramethylammonium hydroxide). Among these compounds, potassium hydroxide and sodium hydroxide are preferable.

The viscosity-enhancing agent is required to develop the processing solution uniformly, and to maintain the adhesion between the light-sensitive layer and the cover sheet. For example, as the viscosity-enhancing agent, an alkali metal salt of polyvinyl alcohol, hydroxyethyl cellulose or carboxymethyl cellulose, is used, and preferably hydroxyethyl cellulose or sodium carboxymethyl cellulose is used.

As the light-shielding agent, any one of a dye and a pigment or a combination thereof may be used insofar as it does not diffuse into the dye-image-receiving layer to occur stains. As typical examples of the light-shielding agent, carbon black can be mentioned.

As a preferable developing agent, use can be made of any one of those which cross-oxidize a dye-image-forming substance and cause substantially no stains even if it is oxidized. These developing agents may be used either singly or in combinations of two or more, and they can be used in the form of a precursor. The developing agent may be contained in a proper layer of the light-sensitive sheet, or in the alkaline processing composition. As specific examples of such a compound, aminophenols and pyrazolidinones can be given. Among these compounds, pyrazolidinones are particularly preferable because of decreased occurrence of stains. Given as examples of these pyrazolidinones are 1-phenyl-3-pyrazolidinone, 1-p-tolyl-4,4-dihydroxymethyl-3-pyrazolidinone, 1-(3′-methyl-phenyl)-4-methyl-4-hydroxymethyl-3-pyrazolidinone, 1-phenyl-4-methyl-4-hydroxymethyl-3-pyrazolidinone, 1-p-tolyl-4-methyl-4-hydroxymethyl-3-pyrazolidinone, and the like.

Any one of the light-sensitive sheet, the cover sheet, and the alkaline processing composition may contain a development accelerator described on pp. 72-91, a hardener described on pp. 146-155, a surfactant described on pp. 201-210, a fluorine-containing compound described on pp. 210-222, a viscosity-enhancing agent on pp. 225-227, an antistatic agent described on pp. 227-230, a polymer latex described on pp. 230-239, a matte agent described on page 240, and the like, each of which is described in JP-A-62-215272. Also, it may contain a tertiary amine latex as described in JP-A-6-273907, JP-A-7-134386, JP-A-7-175193, and JP-A-7-287372.

The thickness of the diffusion-transfer film unit of the present invention is not particularly limited.

The details of the light-exposure method, which can be applied to the present diffusion-transfer film unit, are described in, for example, JP-A-7-219180, paragraphs [0152] to [0153], and JP-A-2000-258879, paragraphs [0006] to [0014].

According to the present invention, it is possible to provide a integrated type color diffusion film unit that can be peeled off, if necessary, and that is not deteriorated in light fastness and curling characteristics, also, after it is peeled off. Further, according to the integrated type color diffusion transfer film unit of the present invention, a peeled image unit can be used as a seal print with ease.

The diffusion transfer film unit of the present invention can be peeled off according to the need, and may be used as a seal print after peeled off.

Further, the diffusion transfer film unit of the present invention is superior in curling characteristics and the fastness of a color image after peeled and sealed.

The present invention will be explained in more detail by way of the following examples, but the invention is not intended to be limited thereto.

### EXAMPLES

### Example 1

I. Preparation of Light-Sensitive Sheet

First, a light-sensitive element (Light-sensitive sheet 101) having the constructions shown in the following Table 1 was prepared. The emulsions mentioned in Table 1 were prepared referring to the methods shown in Table 2.

TABLE 1
Constitution of Light-sensitive sheet 101

| Number of | | | Coated amount |
|---|---|---|---|
| layer | Name of layer | Additive | (g/m²) |
| 22nd layer | Protective | Matting agent (1) | 0.15 |
| | layer | Gelatin | 0.25 |
| | | Surfactant (1) | 5.3 × 10⁻³ |
| | | Surfactant (2) | 4.1 × 10⁻³ |
| | | Surfactant (3) | 3.9 × 10⁻³ |
| | | Additive (1) | 8.0 × 10⁻³ |
| | | Additive (5) | 0.009 |
| 21st layer | Ultraviolet | Ultraviolet absorber (1) | 0.09 |
| | absorbing | Ultraviolet absorber (2) | 0.05 |
| | layer | Ultraviolet absorber (3) | 0.01 |
| | | Additive (2) | 0.17 |
| | | Surfactant (3) | 0.013 |
| | | Surfactant (4) | 0.019 |
| | | Additive (1) | 8.0 × 10⁻³ |
| | | Additive (5) | 0.023 |
| | | Hardener (1) | 0.050 |
| | | Hardener (2) | 0.017 |
| | | Gelatin | 0.52 |
| 20th layer | Blue-light- | Internal-latent-image-type | 0.38 |
| | sensitive | direct positive emulsion: A | (in terms of silver) |
| | layer | Nucleating agent (1) | 2.9 × 10⁻⁶ |
| | (high | Additive (3) | 4.0 × 10⁻³ |
| | sensitivity) | Additive (4) | 0.013 |
| | | Additive (5) | 3.8 × 10⁻³ |
| | | Additive (1) | 9.0 × 10⁻³ |
| | | Surfactant (5) | 9.0 × 10⁻³ |
| | | Gelatin | 0.42 |
| 19th layer | Blue-light- | Internal-latent-image-type | 0.07 |
| | sensitive | direct positive emulsion: B | (in terms of silver) |
| | layer | Internal-latent-image-type | 0.10 |
| | (low | direct positive emulsion: C | (in terms of silver) |
| | sensitivity) | Nucleating agent (1) | 2.5 × 10⁻⁶ |
| | | Additive (3) | 0.022 |
| | | Additive (5) | 9.0 × 10⁻³ |
| | | Additive (1) | 0.013 |
| | | Surfactant (5) | 9.0 × 10⁻³ |
| | | Gelatin | 0.35 |
| 18th layer | White | Titanium dioxide | 0.30 |
| | reflection | Additive (1) | 9.0 × 10⁻³ |
| | layer | Surfactant (1) | 7.2 × 10⁻⁵ |
| | | Additive (5) | 0.011 |
| | | Additive (8) | 2.8 × 10⁻³ |
| | | Gelatin | 0.37 |
| 17th layer | Yellow color | Yellow dye-releasing compound (1) | 0.62 |
| | material layer | High-boiling organic solvent (1) | 0.27 |
| | | Additive (6) | 0.18 |
| | | Additive (7) | 0.09 |
| | | Surfactant (4) | 0.062 |
| | | Surfactant (5) | 0.030 |
| | | Additive (9) | 0.031 |
| | | Additive (1) | 6.0 × 10⁻³ |
| | | Gelatin | 0.87 |
| 16th layer | Intermediate | Additive (10) | 0.013 |
| | layer | Surfactant (1) | 4.0 × 10⁻⁴ |
| | | Additive (1) | 7.0 × 10⁻³ |
| | | Gelatin | 0.42 |
| 15th layer | Color mixing | Additive (11) | 0.47 |
| | prevention | High-boiling organic solvent (2) | 0.23 |
| | layer | Poly(methyl methacrylate) | 0.81 |
| | | Surfactant (5) | 0.019 |
| | | Additive (1) | 2.0 × 10⁻³ |
| | | Additive (12) | 0.61 |
| | | Gelatin | 0.81 |
| 14th layer | Green-light- | Internal-latent-image-type | 0.69 |
| | sensitive | direct positive emulsion: D | (in terms of silver) |
| | layer | Nucleating agent (1) | 2.5 × 10⁻⁶ |
| | (high | Additive (3) | 0.12 |
| | sensitivity) | Additive (5) | 0.014 |
| | | Additive (1) | 3.0 × 10⁻³ |
| | | High-boiling organic solvent (2) | 0.07 |
| | | Surfactant (5) | 0.06 |
| | | Gelatin | 0.97 |
| 13th layer | Green-light- | Internal-latent-image-type | 0.11 |
| | sensitive | direct positive emulsion: E | (in terms of silver) |
| | layer | Internal-latent-image-type | 0.08 |
| | (low | direct positive emulsion: F | (in terms of silver) |
| | sensitivity) | Nucleating agent (1) | 2.7 × 10⁻⁶ |
| | | Additive (3) | 0.011 |
| | | Additive (4) | 0.033 |
| | | Additive (5) | 1.5 × 10⁻³ |
| | | Additive (1) | 0.010 |
| | | Surfactant (5) | 0.024 |
| | | Gelatin | 0.26 |
| 12th layer | Intermediate | Additive (1) | 0.014 |
| | layer | Surfactant (1) | 0.038 |
| | | Surfactant (3) | 4.0 × 10⁻³ |
| | | Additive (5) | 0.014 |
| | | Gelatin | 0.33 |
| 11th layer | Magenta | Magenta dye-releasing compound (1) | 0.56 |
| | color | High-boiling organic solvent (1) | 0.18 |
| | material layer | Additive (13) | 9.3 × 10⁻⁴ |
| | | Additive (5) | 0.02 |
| | | Surfactant (4) | 0.04 |
| | | Additive (14) | 0.02 |
| | | Additive (1) | 7.0 × 10⁻³ |
| | | Gelatin | 0.45 |
| 10th layer | Intermediate | Additive (10) | 0.014 |
| | layer | Surfactant (1) | 3.0 × 10⁻⁴ |
| | | Additive (1) | 9.0 × 10⁻³ |
| | | Gelatin | 0.36 |
| 9th layer | Color-mixing | Additive (11) | 0.38 |
| | prevention | High-boiling organic solvent (2) | 0.19 |
| | layer | Poly(methyl methacrylate) | 0.66 |
| | | Surfactant (5) | 0.016 |
| | | Additive (1) | 2.0 × 10⁻³ |
| | | Additive (12) | 0.49 |
| | | Gelatin | 0.65 |
| 8th layer | Red-light- | Internal-latent-image-type | 0.33 |
| | sensitive | direct positive emulsion: I | (in terms of silver) |
| | layer | Nucleating agent (1) | 6.1 × 10⁻⁶ |
| | (high | Additive (3) | 0.04 |
| | sensitivity) | Additive (5) | 0.01 |
| | | Additive (1) | 1.0 × 10⁻³ |
| | | Additive (2) | 0.08 |
| | | High-boiling organic solvent (2) | 0.04 |
| | | Surfactant (5) | 0.02 |
| | | Gelatin | 0.33 |
| 7th layer | Red-light- | Internal-latent-image-type | 0.10 |
| | sensitive | direct positive emulsion: G | (in terms of silver) |
| | layer | Internal-latent-image-type | 0.11 |
| | (low | direct positive emulsion: H | (in terms of silver) |
| | sensitivity) | Nucleating agent (1) | 2.5 × 10⁻⁵ |
| | | Additive (3) | 0.047 |
| | | Additive (5) | 0.016 |
| | | Additive (1) | 8.0 × 10⁻³ |
| | | Surfactant (5) | 0.02 |
| | | Gelatin | 0.57 |
| 6th layer | White | Titanium dioxide | 1.87 |
| | reflection | Additive (1) | 7.0 × 10⁻³ |
| | layer | Surfactant (1) | 4.0 × 10⁻⁴ |
| | | Additive (5) | 0.02 |
| | | Additive (8) | 0.015 |
| | | Gelatin | 0.73 |
| 5th layer | Cyan color | Cyan dye-releasing compound (1) | 0.25 |
| | material layer | Cyan dye-releasing compound (2) | 0.14 |
| | | High-boiling organic solvent (1) | 0.05 |
| | | Additive (3) | 0.06 |
| | | Additive (5) | 0.01 |
| | | Surfactant (4) | 0.05 |
| | | Additive (9) | 0.05 |
| | | Additive (1) | 4.0 × 10⁻³ |
| | | Hardener (3) | 0.014 |
| | | Gelatin | 0.40 |
| 4th layer | Light- | Carbon black | 1.50 |
| | shielding | Surfactant (1) | 0.08 |
| | layer | Additive (1) | 0.06 |
| | | Additive (5) | 0.06 |
| | | Additive (14) | 0.15 |
| | | Gelatin | 1.43 |
| 3rd layer | Intermediate | Surfactant (1) | 6.0 × 10⁻⁴ |
| | layer | Additive (1) | 9.0 × 10⁻³ |
| | | Additive (5) | 0.013 |
| | | Gelatin | 0.29 |
| 2nd layer | White | Titanium dioxide | 19.8 |
| | reflection | Additive (15) | 0.378 |
| | layer | Additive (16) | 0.094 |
| | | Surfactant (6) | 0.019 |
| | | Additive (8) | 0.16 |
| | | Hardener (1) | 0.02 |
| | | Hardener (2) | 0.007 |
| | | Gelatin | 2.45 |
| 1st layer | Image- | Polymer mordant (1) | 2.22 |
| | receiving | Additive (17) | 0.26 |
| | layer | Surfactant (7) | 0.04 |
| | | Additive (5) | 0.11 |
| | | Hardener (1) | 0.03 |
| | | Hardener (2) | 0.01 |
| | | Gelatin | 3.25 |
| Support | (90 μm of polyethylene terephthalate containing titanium | | |
| | dioxide for preventing light piping, and provided with an | | |
| | undercoat) | | |
| Backing | Curl controlling | Ultraviolet absorber (4) | 0.40 |
| layer | layer | Ultraviolet absorber (5) | 0.10 |
| | | Diacetylcellulose | 4.20 |
| | | (Acetylation degree 51%) | |
| | | Additive (18) | 0.25 |
| | | Barium stearate | 0.11 |
| | | Hardener (4) | 0.50 |

TABLE 2
Emulsions used in Light-sensitive sheet 101

| | | Sphere | External | | |
|---|---|---|---|---|---|
| Number | Name of | equivalent | shapes of | Aspect | Preparation method of |
| of layer | emulsion | diameter(μm) | grain | ratio | emulsion |
| 20th layer | A | 1.3 | Tabular | 7 | The same as Emulsion A |
| | | | (hexagonal) | | in JP-A-2003-107619 |
| 19th layer | B | 1.1 | Tabular | 5 | The same as Emulsion B |
| | | | (hexagonal) | | in JP-A-2003-107619 |
| 19th layer | C | 0.9 | Tabular | 4 | The same as Emulsion C |
| | | | (hexagonal) | | in JP-A-2003-107619 |
| 14th layer | D | 1.1 | Tabular | 7 | The same as Emulsion D |
| | | | (hexagonal) | | in JP-A-2003-107619 |
| 13th layer | E | 1.0 | Tabular | 5 | The same as Emulsion E |
| | | | (hexagonal) | | in JP-A-2003-107619 |
| 13th layer | F | 0.9 | Tabular | 4 | The same as Emulsion F |
| | | | (hexagonal) | | in JP-A-2003-107619 |
| 7th layer | G | 0.8 | Octahedron | — | The same as Emulsion G |
| | | | | | in JP-A-2003-107619 |
| 7th layer | H | 0.7 | Octahedron | — | The same as Emulsion H |
| | | | | | in JP-A-2003-107619 |
| 8th layer | I | 0.6 | Tabular | 7 | The same as Emulsion 101 |
| | | | (hexagonal) | | in JP-A-2003-107619 |

The compounds used for the preparation of the emulsions are shown below.

| | |
|---|---|
| | (E-1) |
| 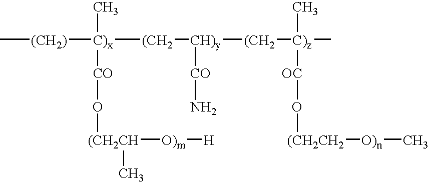 | |
| | (E-2) |
| 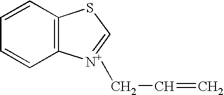 | |
| | (E-3) |
| K₄[Fe(CN)₆]• 3H₂O | |

| | |
|---|---|
| 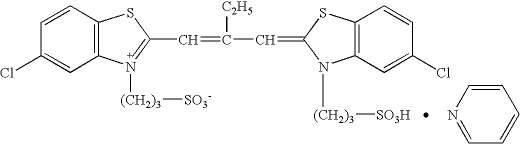 | Molecular weight: 728.77 Molecular formula: C₂₅H₂₆Cl₂N₂O₆S₄. C₅H₅N₁Sensitizing dye (1) |
| 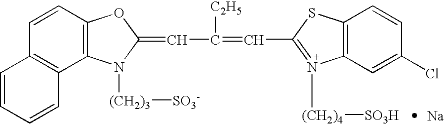 | Molecular weight: 686.24 Molecular formula: C₃₀H₃₁Cl₁N₂O₇S₃. NA₁Sensitizing dye (3) |
| 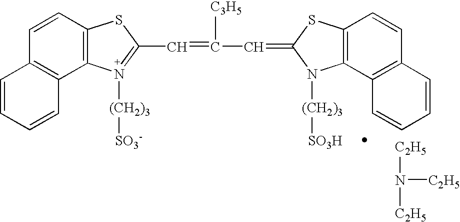 | Molecular weight: 782.09 Molecular formula: C₃₃H₃₂N₂O₆S₄. C₆H₁₄N₁Sensitizing dye (2) |
| 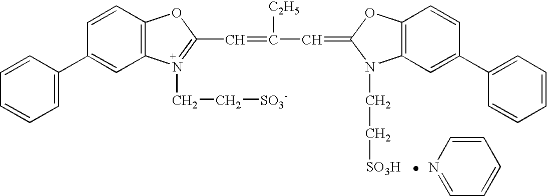 | Molecular weight: 751.89 Molecular formula: C₃₅H₃₂N₂O₈S₂. C₅H₅N₁Sensitizing dye (7) |
| 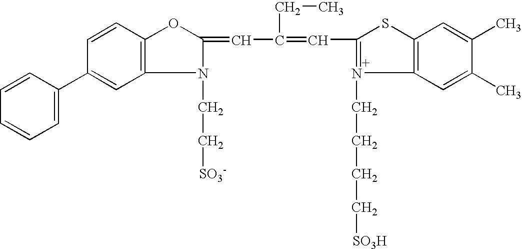 | Molecular weight: 707.96 Molecular formula: C₃₃H₃₆N₂O₇S₃.K₁Sensitizing dye (4) |
| 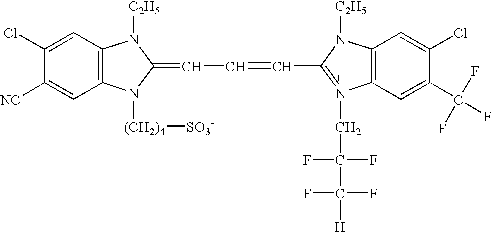 | Molecular weight: 742.57 Molecular formula: C₃₀H₂₃Cl₂F₇N₄O₃S₁Sensitizing dye (6) |
| 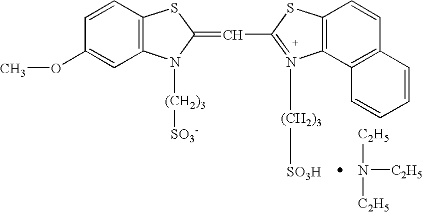 | Molecular weight: 707.96 Molecular formula: C₂₀H₂₆N₂O₇S₄C₆H₅N₁Sensitizing dye (9) |
| 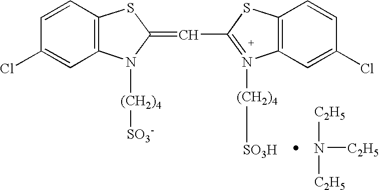 | Molecular weight: 724.83 Molecular formula: C₂₃H₂₄Cl₂N₂O₆S₄. C₆H₁₅N₁Sensitizing dye (5) |
| 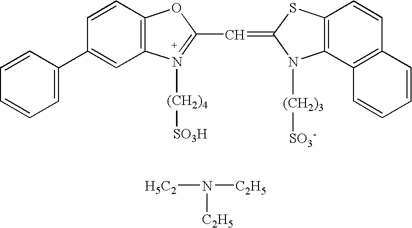 | Molecular weight: 752.00 Molecular formula: C₃₂H₃₀N₂O₇S₃. C₆H₁₅N₁Sensitizing dye (8) |

The compounds used for the preparation of the light-sensitive element (light-sensitive sheet 101) are shown below. 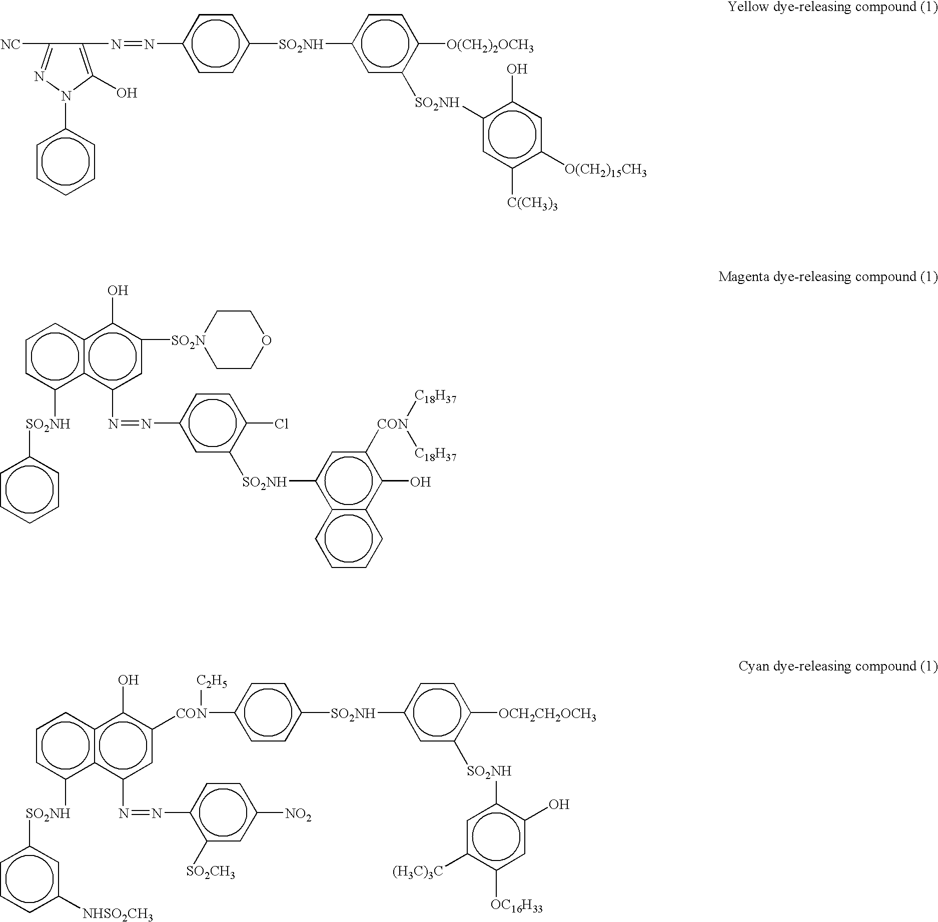 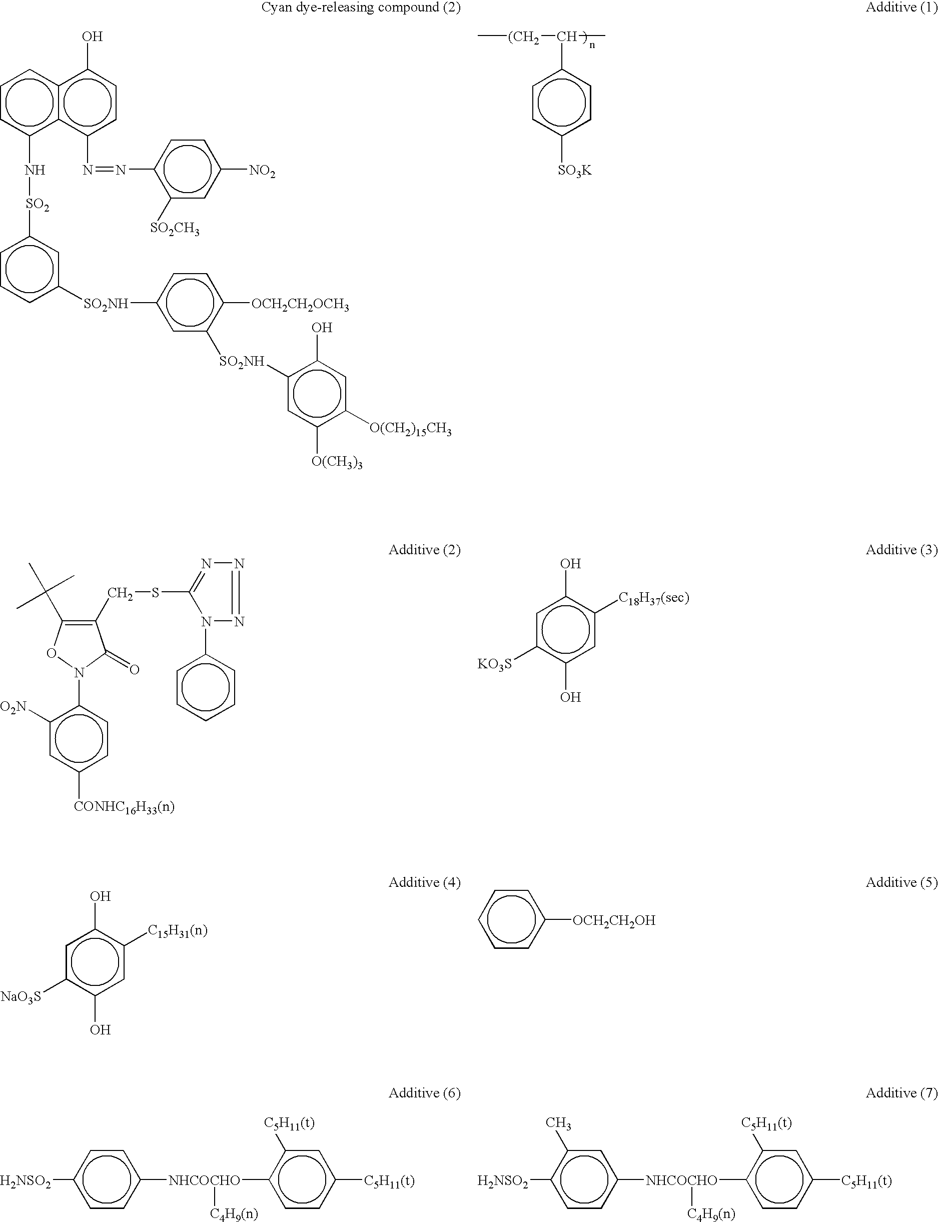
Additive (8)

Carboxymethyl cellulose

(CMC CELLOGEN 6A, trade name, manufactured by Dai-ichi Kogyo Seiyaku Co. Ltd.)

Additive (9)

Polyvinyl alcohol (PVA-220E, trade name)

Polymerization degree about 2,000

Saponification degree 88% 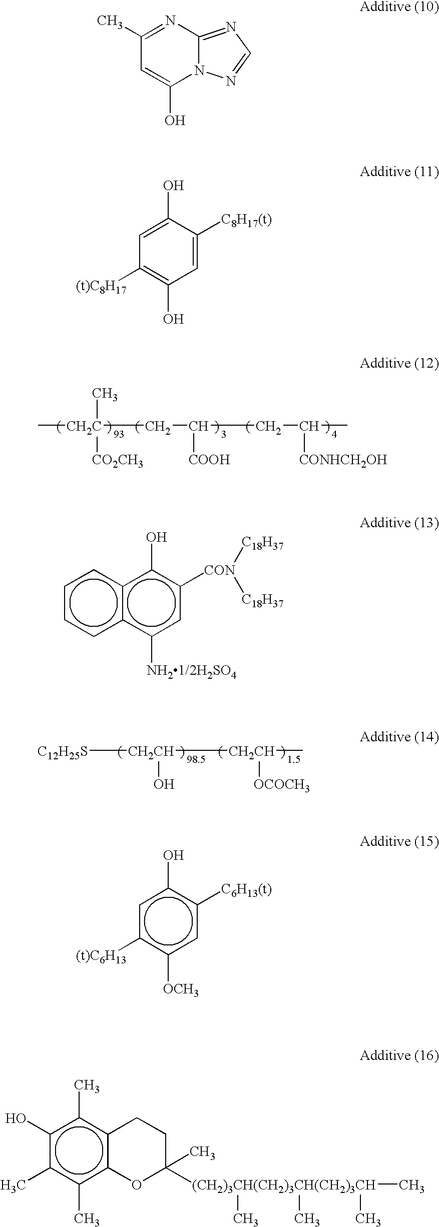 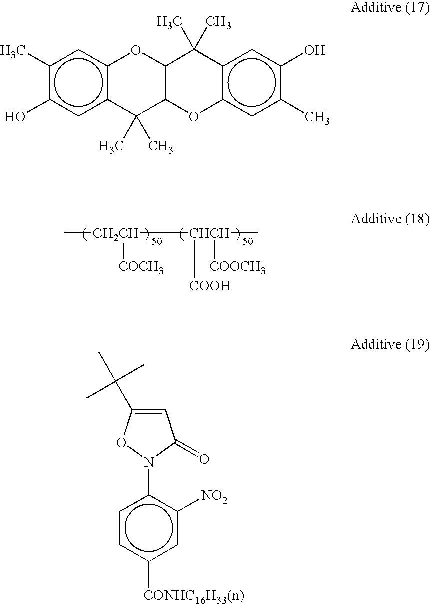
Matt Agent (1)
Latex of sphere polymethyl methacrylate
(average particle diameter: 3 μm) 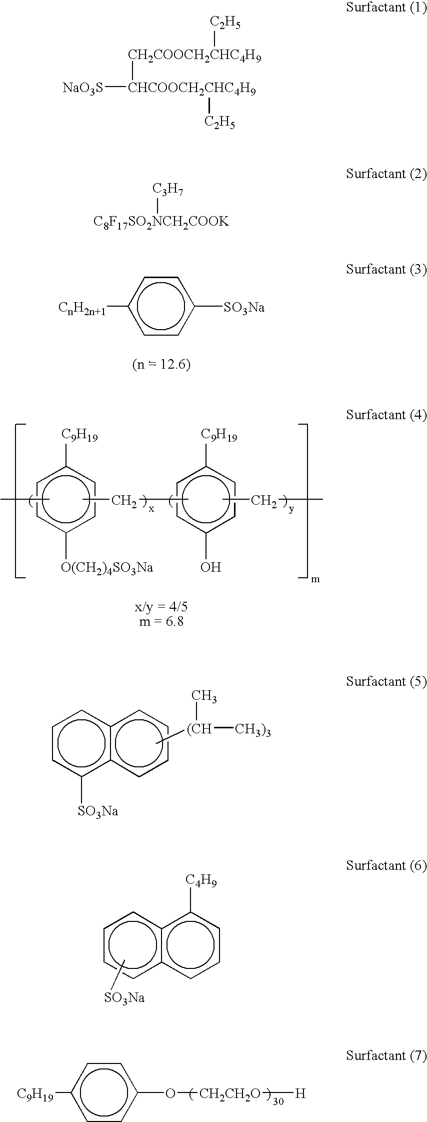 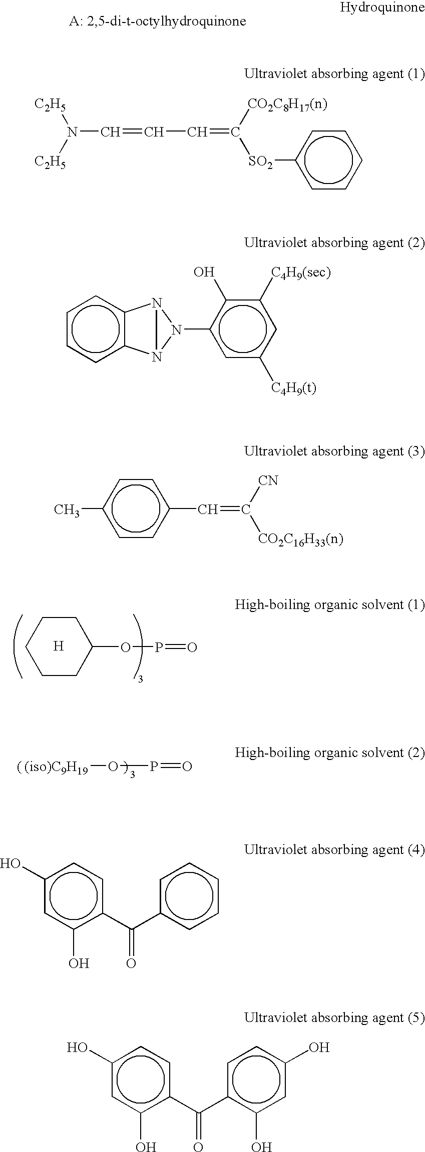 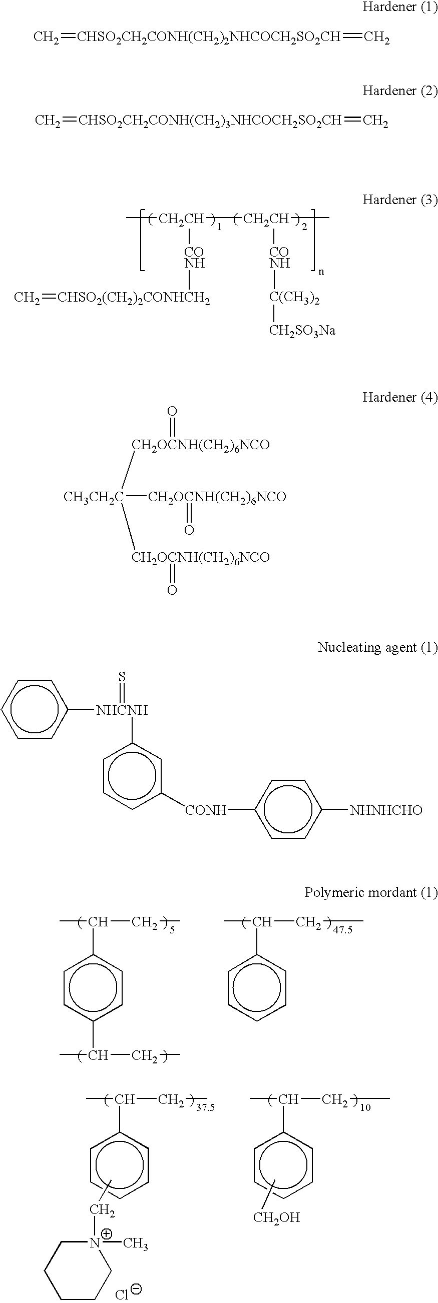
   2. Preparation of Cover Sheet

Supports (1) to (12) each having the constitution shown in Table 3 (including the lamination-type transparent supports that can be used in the present invention) were first manufactured.

Two polyethylene terephthalate transparent supports, which were undercoated and contained a light-piping preventive dye (additive (22)), were used as B1 which was to be disposed on the neutralizing layer side, and as B2 which was to be disposed on the side opposite to the neutralizing layer.

In Table 3, B1-Th is the thickness (μm) of the support B1 disposed on the neutralizing layer side, and B2-Th is the thickness (μm) of the support B2 disposed on the side opposite to the neutralizing layer.

In the production of supports (3) to (11), first, SD-7239 (trade name) manufactured by Dow Coning Toray Silicone Co., Ltd. was applied by a gravure coater to the surface of the support B2, to which surface the support B1 was to be applied, such that the dry amount was 1.0 g/m², dried and rolled to form a peeling layer. Like this, a support on peeling side was manufactured.

Next, an adhesive (BPS-5569K (trade name) manufactured by TOYO INK MFG. CO., LTD.) was applied by a comma coater to the surface of the support B1, to which surface the support B2 was to be applied, such that the dry amount was 20 g/m², and dried to form an adhesive layer. The peeling-layer-coated surface of the support B2 produced in advance was laminated on the adhesive layer-coated surface of the support B1 with a laminator, and then, the laminate was rolled, to manufacture a lamination-type transparent support. Instead of the above-described method, a method in which the peeling-layer-coated surface of the support B2 is coated with an adhesive to form an adhesive layer, and then, it is laminated on the support B1 with a laminator, followed by rolling, may be used.

Separately, SD-7239 manufactured by Dow Coning Toray Silicone Co., Ltd. was applied to the support B1 in a dry amount of 1.0 g/m² by a gravure coater, dried and rolled to manufacture a support (2) provided with the peeling layer.

A support B1 provided with neither peeling layer nor adhesive layer to be applied was referred to as a support (1). A support (12) was the same as the support (1).

TABLE 3
Constitution of supports (1) to (12)

| | | | Coating | | Kind of | Coating |
|---|---|---|---|---|---|---|
| Support | B1-Th | Kind of | thickness of | B2-Th | peeling | thickness of |
| No. | (μm) | adhesive | adhesive(μm) | (μm) | agent | peeling agent (μm) |
| (1) | 75 | None | None | None | None | None |
| (2) | 75 | None | None | None | SD-7239 | 1 |
| (3) | 25 | BPS-5569K | 20 | 25 | SD-7239 | 1 |
| (4) | 25 | BPS-5569K | 20 | 75 | SD-7239 | 1 |
| (5) | 50 | BPS-5569K | 20 | 50 | SD-7239 | 1 |
| (6) | 75 | BPS-5569K | 20 | 25 | SD-7239 | 1 |
| (7) | 25 | BPS-5569K | 20 | 100 | SD-7239 | 1 |
| (8) | 50 | BPS-5569K | 20 | 75 | SD-7239 | 1 |
| (9) | 25 | BPS-5569K | 20 | 125 | SD-7239 | 1 |
| (10) | 25 | BPS-5569K | 20 | 150 | SD-7239 | 1 |
| (11) | 100 | BPS-5569K | 20 | 75 | SD-7239 | 1 |
| (12) | 75 | None | None | None | None | None |

Note:
BPS-5569K was manufactured by TOYO INK MFG CO., LTD.
SD-7239 was manufactured by Dow Coning Toray Silicone Co., Ltd.

Next, layers having a layer constitution as shown in Table 4 were applied to the supports (1) and (3) to (12), to produce cover sheets 101 and 103 to 112. Separately, an adhesive (BPS-5569K (trade name) manufactured by TOYO INK MFG. CO., LTD.) was applied to the peeling layer of the support (2) in a dry amount of 20 g/m², and then layers having a layer constitution as shown in Table 4 were applied thereto, to produce a cover sheet 102.

TABLE 4
Layer constitution of cover sheet

| | | | Coated |
|---|---|---|---|
| Number | | | amount |
| of layer | Name of layer | Additive | (g/m²) |
| Third | Temperature | Temperature compensating | 0.30 |
| layer | compensating | polymer (1) | |
| | layer | Temperature compensating | 0.80 |
| | | polymer (2) | |
| | | Surfactant (8) | 0.005 |
| Second | Alkali | Cellulose acetate | 4.30 |
| layer | barrier | (Acetylation degree 51%) | |
| | layer | Additive (20) | 0.20 |
| | | Additive (21) | 0.20 |
| | | Hardener (2) | 0.40 |
| First | Neutralization | Acid polymer (1) | 10.40 |
| layer | layer | Cellulose acetate | 0.70 |
| | | (Acetylation degree 45%) | |
| | | Hardener (5) | 0.10 |
| Support | | | |
| Backing | Curl | Cellulose acetate | 9.10 |
| layer | controlling | (Acetylation degree 55%) | |
| | layer | Silica (average particle | 0.04 |
| | | diameter: 3 to 4 μm) | |

The followings show chemical structures and the like of compounds used in the cover sheet. 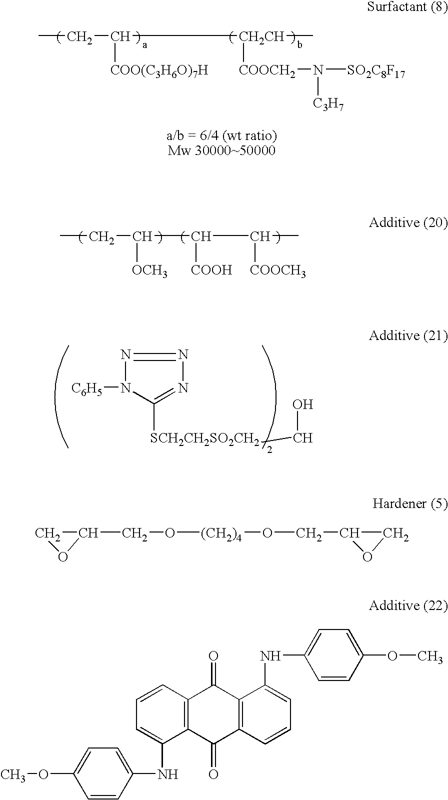 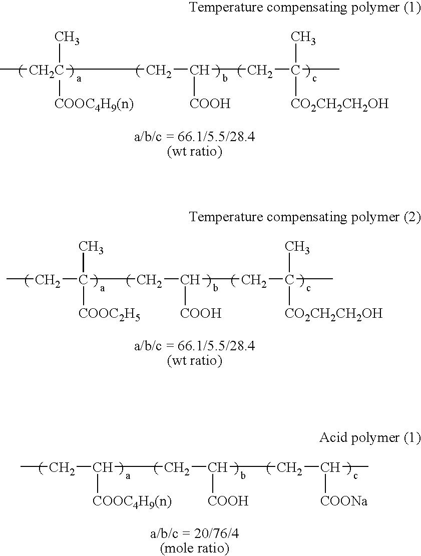
3. Preparation of Alkaline Processing Composition

An alkaline processing composition (processing solution 101) was prepared with the formulation shown below.

| | | |
|---|---|---|
| Silver nitrate | 0.10 | g |
| Carbon black (Dai-nichi Seika Co.) | 160 | g |
| Additive (23) | 8.60 | g |
| Na salt of carboxymethyl cellulose | 58.0 | g |
| Benzylalcohol | 2.50 | g |
| Additive (24) | 2.10 | g |
| Potassium sulfite (anhydride) | 1.90 | g |
| 5-Methylbenzotriazole | 2.50 | g |
| 1-p-Tolyl-4-hydroxymethyl-4-methyl- | 7.00 | g |
| 3-pyrazolidone | | |
| 1-Phenyl-4-hydroxymethyl-4-methyl- | 10.0 | g |
| 3-pyrazolidone | | |
| Potassium hydroxide | 56.0 | g |
| Aluminum nitrate | 0.60 | g |
| Zinc nitrate | 0.60 | g |
| Additive (25) | 6.60 | g |
| Additive (14) | 1.80 | g |
| 1,2-Benzisothiazoline-3-one | 0.003 | g |

0.8 g of the processing solution having the above formulation was filled in a container capable of rupturing by pressure.

The followings show the compounds used in the alkaline processing composition.

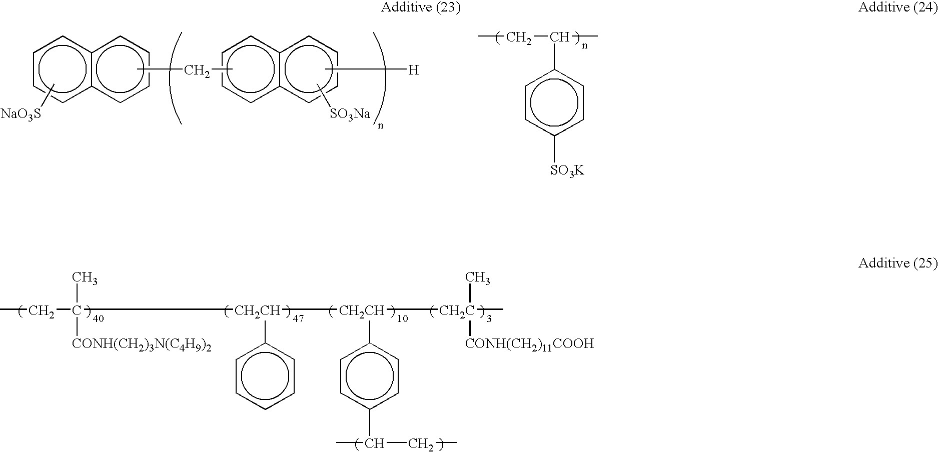

Using the aforementioned light-sensitive sheet 101, the aforementioned cover sheets 101 to 112 and the aforementioned processing solution 101, color diffusion transfer photographic units 101 to 112 were produced according to the method described in, for example, JP-A-7-159931. After each color diffusion transfer photographic unit was mounted on a camera, it was exposed to light from the cover sheet side, and developed using pressure rollers which were so controlled that the thickness of the processing solution between the both materials was 55 μm, to carry out the light exposure and development of the units 101 to 112. The processing was carried out at 25° C.

As to the evaluation of the thickness of the units, the thickness of each unit was measured both in a non-peeled state and in a peeled state. In addition, sensory evaluation, when the unit was felt with a hand, was made.

With regard to the units 102 to 111 having the peeling layer, after each unit was peeled off at the boundary between the peeling layer and the adhesive layer, it was applied to a desired base material in the manner that the adhesive-layer-surface faced downward (hereinafter called a peeled seal state), to carry out various evaluations. With regard to the unit 101 having no peeling layer, an adhesive was applied to the back side of the cover seat of the unit 101 by using a strong adhesive seal machine manufactured by TOMY (K.K.), to prepare the unit 112 (seal with a back adhesive). The thus-obtained unit 112 was evaluated as a substitution for the unit put in the peeled seal state.

As to the curling property in the peeled seal state, it was evaluated in the following manner: the adhesive surface of the unit was applied to a 87-μm-thick paper, which was then stored at 25° C. under 55% RH for 7 days, to measure the height of a rise which causes curling when the unit was placed on a flat surface, thereby evaluating the curling. The height of the rise of the unit when unit 101 was placed in a non-peeled state, on a flat surface, was set as standard for evaluation. The case where the height of rise of a peeled seal was equal to or less than standard was rated as “⊚”, and the case where the height of rise of a peeled seal was higher than standard was rated as “X”.

As to the fading property of the peeled seal, these samples were exposed to 3,000 lux fluorescent light irradiation for 40 days, to examine the fading property of a color image. The fading of each samples was evaluated for the point where the unit 101 in a non-peeled state gave a cyan color image density of 2.0 before exposure to the light irradiation, as fading standard. The case where the fading of a peeled seal was equal to or smaller than that of standard was rated as “⊚”, and the case where the fading of a peeled seal was inferior to that of the standard was rated as “X”. The results are shown collectively in Table 5.

TABLE 5
Result of measuring and evaluation

| | | Non-peeled state | | Peeled state (Seal print) | | Seal with an adhesive at back side | | Curling | Fading |
|---|---|---|---|---|---|---|---|---|---|
| | Used | Measured value | | Measured value | | Measured value | | property | property |
| Unit | cover | of unit thickness | Sensory | of unit thickness | Sensory | of unit thickness | Sensory | in peeled | in peeled |
| No. | sheet | (μm) | evaluation | (μm) | evaluation | (μm) | evaluation | seal state | seal state |
| Unit-101 | Cover | 239 | ⊚ | Could not | — | — | — | — | — |
| | sheet-101 | | | measured | | | | | |
| Unit-102 | Cover | 260 | ⊚ | 178 | ⊚ | — | — | X | X |
| | sheet-102 | | | | | | | | |
| Unit-103 | Cover | 235 | ⊚ | 203 | ⊚ | — | — | ⊚ | ⊚ |
| | sheet-103 | | | | | | | | |
| Unit-104 | Cover | 285 | ⊚ | 203 | ⊚ | — | — | ⊚ | ⊚ |
| | sheet-104 | | | | | | | | |
| Unit-105 | Cover | 285 | ⊚ | 228 | ◯ | — | — | ⊚ | ⊚ |
| | sheet-105 | | | | | | | | |
| Unit-106 | Cover | 285 | ⊚ | 253 | X | — | — | ⊚ | ⊚ |
| | sheet-106 | | | | | | | | |
| Unit-107 | Cover | 310 | ◯ | 203 | ⊚ | — | — | ⊚ | ⊚ |
| | sheet-107 | | | | | | | | |
| Unit-108 | Cover | 310 | ◯ | 228 | ◯ | — | — | ⊚ | ⊚ |
| | sheet-108 | | | | | | | | |
| Unit-109 | Cover | 335 | ◯ | 203 | ⊚ | — | — | ⊚ | ⊚ |
| | sheet-109 | | | | | | | | |
| Unit-110 | Cover | 360 | X | 203 | ⊚ | — | — | ⊚ | ⊚ |
| | sheet-110 | | | | | | | | |
| Unit-111 | Cover | 360 | X | 278 | X | — | — | ⊚ | ⊚ |
| | sheet-111 | | | | | | | | |
| Unit-112 | Cover | 239 | ⊚ | Could not | — | 259 | X | ⊚ | ⊚ |
| | sheet-112 | | | measured | | | | | |

It is clear from Table 5 that the color diffusion transfer photographic film units corresponding to the above item (3) of the present specification each had a low thickness and felt good when they were touched with hand both in the non-peeled state and in the peeled seal state. In addition, the color diffusion transfer photographic film units of the present invention in the peeled seal state had curling characteristics and fading characteristics equal to or more excellent than those in the non-peeled state, showing that the color diffusion transfer photographic film unit of the present invention was superior.

Specifically, the unit 102 of the comparative example was free from a thick feel and felt good to the touch when it was put in the peeled seal state. However, when the unit 102 was put in the peeled seal state, it was deteriorated in curling and fading. The unit 112 of the comparative example not only formed a thick seal when peeled off, but also a customer needed much effort to put the unit into a seal state. Therefore, it was impractical.

On the other hand, since the image-formation section was sandwiched between two supports, the units 103 to 111 according to the present invention, even in the peeled seal state, were kept good curling and fading characteristics. Further, in the units 103 to 105 and 107 to 109, the image-formation section was sandwiched between two supports, and the thickness of the support to be stuck to the base material was proper. Therefore, the units 103 to 105 and 107 to 109 were thin and felt good to the touch both in the non-peeled state and in the peeled seal state, and kept good curling and fading characteristics.

### Example 2

In the method of producing a color diffusion transfer photographic unit in Example 1, the light-sensitive element was changed to the light-sensitive sheet 201, and the developed thickness of the processing solution was changed, to form units, thereby evaluating the effect of the present invention. As the cover sheet, the cover sheets 101 to 112 used in Example 1 were used.

First, a light-sensitive sheet (Light-sensitive sheet 201) having the constructions shown in the following Table 6 was prepared.

TABLE 6
Constitution of Light-sensitive sheet 201

| Number | Name of | | Coated amount |
|---|---|---|---|
| of layer | layer | Additive | (g/m²) |
| 16th | Protective | Matting agent (1) | 0.15 |
| layer | layer | Gelatin | 0.25 |
| | | Surfactant (1) | 5.3 × 10⁻³ |
| | | Surfactant (8) | 1.4 × 10⁻³ |
| | | Surfactant (3) | 3.9 × 10⁻³ |
| | | Additive (1) | 8.0 × 10⁻³ |
| | | Additive (5) | 0.009 |
| 15th | Ultraviolet | Ultraviolet absorber | 0.09 |
| layer | absorbing | (1) | |
| | layer | Ultraviolet absorber | 0.05 |
| | | (2) | |
| | | Ultraviolet absorber | 0.01 |
| | | (3) | |
| | | Additive (2) | 0.17 |
| | | Surfactant (3) | 0.013 |
| | | Surfactant (4) | 0.019 |
| | | Additive (1) | 8.0 × 10⁻³ |
| | | Additive (5) | 0.023 |
| | | Hardener (1) | 0.050 |
| | | Hardener (2) | 0.017 |
| | | Gelatin | 0.52 |
| 14th | Blue-light- | Surface-latent-image- | 0.26 |
| layer | sensitive | type Emulsion: J | (in terms of |
| | layer | | silver) |
| | | Additive (19) | 4.2 × 10⁻³ |
| | | Additive (3) | 2.6 × 10⁻³ |
| | | Additive (4) | 7.7 × 10⁻³ |
| | | Additive (5) | 2.6 × 10⁻³ |
| | | Additive (1) | 6.2 × 10⁻³ |
| | | Additive (2) | 1.1 × 10⁻² |
| | | Gelatin | 0.10 |
| 13th | Yellow color | Yellow dye-releasing | 0.38 |
| layer | material | compound (1) | |
| | layer | High-boiling organic | 0.24 |
| | | solvent (1) | |
| | | Additive (6) | 0.11 |
| | | Additive (7) | 0.06 |
| | | Surfactant (4) | 0.038 |
| | | Surfactant (5) | 0.018 |
| | | Additive (9) | 0.019 |
| | | Additive (1) | 4.7 × 10⁻³ |
| | | Gelatin | 0.53 |
| 12th | Intermediate | Additive (10) | 0.01 |
| layer | layer | Surfactant (1) | 2.0 × 10⁻⁴ |
| | | Additive (1) | 7.0 × 10⁻³ |
| | | Gelatin | 0.23 |
| 11th | Color mixing | Additive (11) | 0.31 |
| layer | prevention | High-boiling | 0.16 |
| | layer | organic solvent (2) | |
| | | Poly(methyl | 0.54 |
| | | methacrylate) | |
| | | Surfactant (5) | 0.019 |
| | | Additive (1) | 2.0 × 10⁻³ |
| | | Gelatin | 0.64 |
| 10th | Green-light- | Surface-latent- | 0.27 |
| layer | sensitive | image-type | (in terms of |
| | layer | emulsion: K | silver) |
| | | Additive (2) | 0.024 |
| | | Additive (4) | 0.026 |
| | | Additive (5) | 1.5 × 10⁻³ |
| | | Additive (1) | 0.010 |
| | | Surfactant (5) | 0.01 |
| | | Gelatin | 0.06 |
| 9th | Magenta | Magenta dye-releasing | 0.35 |
| layer | color | compound (1) | |
| | material | High-boiling organic | 0.16 |
| | layer | solvent (1) | |
| | | Additive (13) | 9.3 × 10⁻⁴ |
| | | Additive (5) | 0.02 |
| | | Surfactant (4) | 0.04 |
| | | Additive (14) | 0.02 |
| | | Additive (1) | 7.0 × 10⁻³ |
| | | Gelatin | 0.37 |
| 8th | Intermediate | Additive (10) | 0.014 |
| layer | layer | Surfactant (1) | 4.4 × 10⁻⁴ |
| | | Additive (1) | 1.4 × 10⁻² |
| | | Gelatin | 0.45 |
| 7th | Color-mixing | Additive (11) | 0.32 |
| layer | prevention | High-boiling organic | 0.18 |
| | layer | solvent (2) | |
| | | Poly(methyl | 0.56 |
| | | methacrylate) | |
| | | Surfactant (5) | 0.022 |
| | | Additive (1) | 2.0 × 10⁻³ |
| | | Gelatin | 0.65 |
| 6th | Red-light- | Surface-latent- | 0.22 |
| layer | sensitive | image-type | (in terms of |
| | layer | emulsion: L | silver) |
| | | Additive (3) | 2.7 × 10⁻³ |
| | | Additive (5) | 3.9 × 10⁻³ |
| | | Additive (1) | 4.4 × 10⁻³ |
| | | Additive (2) | 1.2 × 10⁻² |
| | | High-boiling | 0.04 |
| | | organic solvent (2) | |
| | | Surfactant (5) | 5.6 × 10⁻³ |
| | | Gelatin | 0.08 × 10⁻² |
| 5th | Cyan color | Cyan dye-releasing | 0.13 |
| layer | material layer | compound (1) | |
| | | Cyan dye-releasing | 0.07 |
| | | compound (2) | |
| | | High-boiling organic | 0.08 |
| | | solvent (1) | |
| | | Additive (6) | 0.02 |
| | | Additive (7) | 0.01 |
| | | Surfactant (4) | 0.02 |
| | | Additive (9) | 0.024 |
| | | Additive (1) | 4.0 × 10⁻³ |
| | | Hardener (3) | 0.007 |
| | | Gelatin | 0.24 |
| 4th | Light- | Carbon black | 1.50 |
| layer | shielding | Surfactant (1) | 0.03 |
| | layer | Additive (1) | 0.06 |
| | | Additive (5) | 0.08 |
| | | Additive (14) | 0.09 |
| | | Gelatin | 0.88 |
| 3rd | Intermediate | Surfactant (1) | 6.0 × 10⁻⁴ |
| layer | layer | Additive (1) | 9.0 × 10⁻³ |
| | | Additive (5) | 0.013 |
| | | Gelatin | 0.29 |
| 2nd | White | Titanium dioxide | 18.0 |
| layer | reflection | Additive (15) | 0.378 |
| | layer | Additive (16) | 0.094 |
| | | Surfactant (6) | 0.019 |
| | | Additive (8) | 0.16 |
| | | Hardener (1) | 0.02 |
| | | Hardener (2) | 0.007 |
| | | Gelatin | 2.80 |
| 1st | Image- | Polymer mordant (1) | 2.22 |
| layer | receiving | Additive (17) | 0.26 |
| | layer | Surfactant (7) | 0.04 |
| | | Additive (5) | 0.11 |
| | | Hardener (1) | 0.03 |
| | | Hardener (2) | 0.01 |
| | | Gelatin | 3.25 |
| Support | (90 μm of polyethylene terephthalate containing | | |
| | titanium dioxide for preventing light piping, and | | |
| | provided with an undercoat) | | |
| Backing | Curl | Ultraviolet absorber | 0.40 |
| layer | controlling | (4) | |
| | layer | Ultraviolet absorber | 0.10 |
| | | (5) | |
| | | Diacetylcellulose | 4.20 |
| | | (Acetylation degree | |
| | | 51%) | |
| | | Additive (18) | 0.25 |
| | | Barium stearate | 0.11 |
| | | Hardener (4) | 0.50 |

As the emulsions used in Example 2, three types of silver halide emulsions, specifically, the following surface-latent-image-type emulsions-J, K and L were prepared by the preparation method shown below. These emulsions are shown in Table 7.

Emulsion-K

To 0.7 L of an aqueous gelatin solution containing 0.005 mol of potassium bromide and 1.1 g of low-molecular-weight gelatin having an average molecular weight of 20,000 or less, were added 26.5 mL of an aqueous solution of silver nitrate at a concentration of 0.58 mol/L and 46.4 ml of an aqueous solution containing potassium bromide at a concentration of 0.42 mol/L and 1.5% by mass of low-molecular-weight gelatin having an average molecular weight of 20,000 or less, at the same time, with vigorous stirring, over a period of 1 minute by a double-jet method (1st addition). During the addition, the aqueous gelatin solution was kept at 35° C. After 0.5 g of potassium bromide was added, the temperature of the solution was raised to 75° C. at a gradient of 1.5° C./minute.

After the temperature reached 75° C., 0.16 L of an aqueous gelatin solution containing 16% by mass of deionized gelatin having a Ca content of 100 ppm or less (1st addition) and 5 ml of 4.9% sulfuric acid aqueous solution were added. Subsequently, an aqueous solution of silver nitrate at a concentration of 1.88 mol/L and an aqueous solution of potassium bromide at a concentration of 1.88 mol/L were added, at an accelerated flow rate (the final flow rate was 3.5 times the initial flow rate) over a period of 44 minutes by a double-jet method (2nd addition, the amount of the aqueous solution of silver nitrate used was 366 mL, and the amount of the aqueous solution of potassium bromide used was 375 mL). Next, 0.08 L of an aqueous gelatin solution containing 14% by mass of deionized gelatin having a Ca content of 100 ppm or less was added (2nd addition). Subsequent to the addition, 2 mg of sodium benzenethiosulfate was added. After that, an aqueous solution of silver nitrate at a concentration of 1.88 mol/L and an aqueous solution of potassium bromide at a concentration of 1.88 mol/L were added, at an accelerated flow rate (the final flow rate was 1.2 times the initial flow rate), over a period of 11 minutes, by a double-jet method (3rd addition, the amount of the aqueous solution of silver nitrate used was 157 ml, and the amount of the aqueous solution of potassium bromide used was 163 mL). Next, after 4.6 g of potassium bromide was added, the resulting emulsion was washed with water according to a usual flocculation method. After that, deionized gelatin, 2-phenoxyethanol, and methyl p-hydroxybenzoate were added. After the addition, pH was adjusted to 5.8 and pAg was adjusted to 8.8 in order that 1.35 mol of silver and 84 g of gelatin were contained per kg of the emulsion. 0.74 kg of the emulsion prepared in this manner was dissolved under heating, and the mixture was heated to 55° C. Then, 0.5 g of potassium iodide, 4.2×10⁻⁴ mol of the sensitizing dye (6) and 5.4×10⁻⁴ mol of the sensitizing dye (7) were added to the mixture, which was then ripened for 30 minutes. Next, 5.0×10⁻⁴ mol of potassium thiocyanate, 1.4×10⁻⁵ mol of potassium tetrachloroaurate and 1.2×10⁻⁵ mol of sodium thiosulfate were added to the mixture, which was then ripened for 60 minutes. The compound E-4 was added in an amount of 1.0×10⁻³ mol during ripening, and the compound E-5 was added in an amount of 3.2×10⁻⁴ mol at the end of the ripening to the mixture, to complete the preparation of the emulsion.

The diameter of a circle, whose area is equal to the projected area of an individual grain when seen in the main plane direction thereof, is referred to as a circle equivalent diameter. As a result of the observation by means of an electron microscope, the average of grain thicknesses hi (=Σhi×ni/Σni) was 0.135 μm and the average of circle equivalent diameters Di of grains (=ΣDi×ni/Σni) was 1.15 μm. The average aspect ratio defined by the average of circle equivalent diameters Di/the average of grain thicknesses hi was 8.5.

Emulsion-J

In the method of preparing the emulsion-K, 9.2×10⁻⁴ mol of the sensitizing dye (9) was added in place of the sensitizing dyes (6) and (7), to prepare an emulsion-J.

Emulsion-L

In the method of preparing the emulsion-K, 8.4×10⁻⁴ mol of the sensitizing dye (1), 2.6×10⁻⁵ mol of the sensitizing dye (2) and 1.7×10⁻⁴ mol of the sensitizing dye (3) were added in place of the sensitizing dyes (6) and (7), to prepare an emulsion-L.

TABLE 7
Emulsions used in Light-sensitive sheet 201

| | | Sphere | | |
|---|---|---|---|---|
| Number | Name of | equivalent | External | Aspect |
| of layer | emulsion | diameter(μm) | shapes of grain | ratio |
| 14th layer | J | 0.63 | Tabular (hexagonal) | 8.5 |
| 10th layer | K | 0.63 | Tabular (hexagonal) | 8.5 |
| 6th layer | L | 0.63 | Tabular (hexagonal) | 8.5 |

The compounds used for the preparation of the emulsions are shown below.

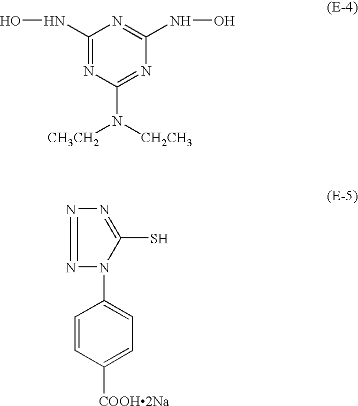

Using the light-sensitive sheet 201, the cover sheets 101 to 112 and a processing solution 101, color diffusion transfer photographic units 201 to 212 were produced by, for example, a method as described in JP-A-7-159931. These color diffusion transfer photographic units were subjected to from light exposure to developing processing using a light-exposure-development-processing apparatus with a built-in light-exposure apparatus using LEDs of three colors for blue, green and red. After the color diffusion transfer photographic units 201 to 212 were mounted on the light-exposure-development processing apparatus, they were exposed to light using the LEDs as a light source from the cover sheet side, and developed using pressure rollers so adjusted that the thickness of the processing solution filled between the both materials was 38 μm, to carry out the light exposure and development of the units 201 to 212. The processing was carried out at 25° C.

As to the evaluation of the thickness of the units, the thickness of each unit was measured both in a non-peeled state and in a peeled state, in the same manner as in Example 1. In addition, sensory evaluation, when the unit was felt with a hand, was made. The method and criterions of the sensory evaluation were the same as those in Example 1.

With regard to the units 202 to 211 having the peeling layer, after each unit was peeled off at the boundary between the peeling layer and the adhesive layer, it was applied to a desired base material in the manner that the adhesive-layer-surface faced downward (hereinafter called a peeled seal state), to make various evaluations. With regard to the unit 201 having no peeling layer, an adhesive was applied to the back side of the cover seat of the unit 201 by using a strong adhesive seal machine manufactured by TOMY (K.K.), to prepare the unit 212 (seal with a back adhesive). The thus-obtained unit 212 was evaluated as a substitution for the unit put in the peeled seal state.

As to the curling in the peeled seal state, evaluation was made in the same manner as in Example 1 except that the height of a rise, when the unit 201 put in the non-peeled state was placed on a flat surface, was set as a standard.

As to the fading property in the peeled seal state, the degree of fading was evaluated in the same manner as in Example 1, except for by using the point where the unit 201 in a non-peeled state gave a cyan color image density of 2.0 before irradiated with light, as a fading standard. The results are shown collectively in Table 8.

TABLE 8
Result of measuring and evaluation

| | | Non-peeled state | | Peeled state (Seal print) | | Seal with an adhesive at back side | | Curling | Fading |
|---|---|---|---|---|---|---|---|---|---|
| | Used | Measured value | | Measured value | | Measured value | | property | property |
| Unit | cover | of unit thickness | Sensory | of unit thickness | Sensory | of unit thickness | Sensory | in peeled | in peeled |
| No. | sheet | (μm) | evaluation | (μm) | evaluation | (μm) | evaluation | seal state | seal state |
| Unit-201 | Cover | 234 | ⊚ | Could not | — | — | — | — | — |
| | sheet-101 | | | measured | | | | | |
| Unit-202 | Cover | 255 | ⊚ | 173 | ⊚ | — | — | X | X |
| | sheet-102 | | | | | | | | |
| Unit-203 | Cover | 230 | ⊚ | 198 | ⊚ | — | — | ⊚ | ⊚ |
| | sheet-103 | | | | | | | | |
| Unit-204 | Cover | 280 | ⊚ | 198 | ⊚ | — | — | ⊚ | ⊚ |
| | sheet-104 | | | | | | | | |
| Unit-205 | Cover | 280 | ⊚ | 223 | ◯ | — | — | ⊚ | ⊚ |
| | sheet-105 | | | | | | | | |
| Unit-206 | Cover | 280 | ⊚ | 248 | X | — | — | ⊚ | ⊚ |
| | sheet-106 | | | | | | | | |
| Unit-207 | Cover | 305 | ◯ | 198 | ⊚ | — | — | ⊚ | ⊚ |
| | sheet-107 | | | | | | | | |
| Unit-208 | Cover | 305 | ◯ | 223 | ◯ | — | — | ⊚ | ⊚ |
| | sheet-108 | | | | | | | | |
| Unit-209 | Cover | 330 | ◯ | 198 | ⊚ | — | — | ⊚ | ⊚ |
| | sheet-109 | | | | | | | | |
| Unit-210 | Cover | 355 | X | 198 | ⊚ | — | — | ⊚ | ⊚ |
| | sheet-110 | | | | | | | | |
| Unit-211 | Cover | 355 | X | 273 | X | — | — | ⊚ | ⊚ |
| | sheet-111 | | | | | | | | |
| Unit-212 | Cover | 234 | ⊚ | Could not | — | 254 | X | ⊚ | ⊚ |
| | sheet-112 | | | measured | | | | | |

It is clear from Table 8 that the color diffusion transfer photographic film units corresponding to the above item (3) of the present specification each had a low thickness and felt good when they were touched with hand both in the non-peeled state and in the peeled seal state. In addition, the color diffusion transfer photographic film units of the present invention in the peeled seal state had curling characteristics and fading characteristics equal to or more excellent than those in the non-peeled state, showing that the color diffusion transfer photographic film unit of the present invention was superior.

Specifically, the unit 202 of the comparative example was free from a thick feel and felt good to the touch when it was put in the peeled seal state. However, when the unit 202 was put in the peeled seal state, it was deteriorated in curling and fading. The unit 212 of the comparative example not only formed a thick seal when peeled off, but also a customer needed much effort to put the unit into a seal state. Therefore, it was impractical.

On the other hand, since the image-formation section was sandwiched between two supports, the units 203 to 211 according to the present invention, even in the peeled seal state, were kept good curling and fading characteristics. Further, in the units 203 to 205 and 207 to 209, the image-formation section was sandwiched between two supports, and the thickness of the support to be stuck to the base material was proper. Therefore, the units 203 to 205 and 207 to 209 were thin and felt good to the touch both in the non-peeled state and in the peeled seal state, and kept good curling property and fading characteristics.

Having described our invention as related to the present embodiments, it is our intention that the invention not be limited by any of the details of the description, unless otherwise specified, but rather be construed broadly within its spirit and scope as set out in the accompanying claims.

1. A diffusion transfer film unit, comprising:
(i) a light-sensitive sheet provided, on a transparent support, with an image-receiving layer, a white reflecting layer, a light-shielding layer and at least one silver halide emulsion layer combined with at least one dye-image-forming substance in this order, on the side of transparent cover sheet described below;
(ii) a transparent cover sheet provided, on another support, with a neutralizing layer and a neutralizing timing layer in this order on the light-sensitive sheet side; and
(iii) a light-shielding alkaline processing composition to be developed between the light-sensitive sheet and the transparent cover sheet;
in which (i) the light-sensitive sheet, (ii) the transparent cover sheet and (iii) the light-shielding alkaline processing composition are arranged such that the diffusion transfer film unit is exposed to light through the transparent cover sheet;
wherein an adhesive layer and a peeling-agent layer are arranged so that they are adjacent to each other, the adhesive layer and the peeling-agent layer are disposed at a position closer to the light-exposure position than the image-receiving layer in the light-sensitive sheet or at any position in the transparent cover sheet, and the adhesive layer is disposed on the side closer to the image-receiving layer than the peeling-agent layer.

2. The diffusion transfer film unit according to claim 1,
wherein the silver halide emulsion in the light-sensitive sheet comprises an internal-latent-image-type direct positive silver halide emulsion.

3. The diffusion transfer film unit according to claim 1,
wherein the silver halide emulsion in the light-sensitive sheet comprises a negative type silver halide emulsion.

4. The diffusion transfer film unit according to claim 1,
wherein the diffusion transfer film unit is exposed to light by using an exposure head having plural light sources different from each other each emitting light in a specific wavelength region.

5. The diffusion transfer film unit according to claim 1, which is used for a seal print.

6. A diffusion transfer film unit, comprising:
(i) a light-sensitive sheet provided, on a transparent support, with an image-receiving layer, a white reflecting layer, a light-shielding layer and at least one silver halide emulsion layer combined with at least one dye-image-forming substance in this order, on the side of transparent cover sheet described below;
(ii) a transparent cover sheet provided, on a lamination-type transparent support having a constitution in which an adhesive layer and a peeling-agent layer are sandwiched between two supports, with a neutralizing layer and a neutralizing timing layer in this order on the light-sensitive sheet side; and
(iii) a light-shielding alkaline processing composition to be developed between the light-sensitive sheet and the transparent cover sheet;
in which (i) the light-sensitive sheet, (ii) the transparent cover sheet and (iii) the light-shielding alkaline processing composition are arranged such that the diffusion transfer film unit is exposed to light through the transparent cover sheet.

7. The diffusion transfer film unit according to claim 6,
wherein each thickness of the two supports constituting the lamination-type transparent support satisfies the relationship given by the following equations:
B1(Th)≦B2(Th)
50 μm≦B1(Th)+B2(Th)≦150 μm
wherein, B1(Th) represents the thickness of the support on the neutralizing layer side, and B2(Th) represents the thickness of the support on the side opposite to the neutralizing layer.

8. The diffusion transfer film unit according to claim 6,
wherein the lamination-type transparent support comprises a polyester film.

9. The diffusion transfer film unit according to claim 6,
wherein the silver halide emulsion in the light-sensitive sheet comprises an internal-latent-image-type direct positive silver halide emulsion.

10. The diffusion transfer film unit according to claim 6,
wherein the silver halide emulsion in the light-sensitive sheet comprises a negative type silver halide emulsion.

11. The diffusion transfer film unit according to claim 6,
wherein the diffusion transfer film unit is exposed to light by using an exposure head having plural light sources different from each other each emitting light in a specific wavelength region.

12. The diffusion transfer film unit according to claim 6, which is used for a seal print.
